(19) United States
(12) Patent Application Publication
(10) Pub. No.: US 2008/0030090 A1
(43) Pub. Date: Feb. 7, 2008

(54) Magnetic power transmission system with RD motor

(75) Inventors: Noriyuki Abe, Saitama-ken (JP); Shigemitsu Akutsu, Saitama-ken (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Honda Motor Co., Ltd.

(21) Appl. No.: 11/882,736

(22) Filed: Aug. 3, 2007

(30) Foreign Application Priority Data
Aug. 4, 2006 (JP) 213905/2006

(51) Int. Cl. H02K 49/00; H02P 15/00

(52) U.S. Cl. 310/103

(57) ABSTRACT

[Object] To provide a magnetic power transmission system which is capable of enhancing power transmission efficiency and power transmission capacity and reducing manufacturing costs of the system, while maintaining the advantageous effects obtained by performing power transmission by magnetic forces.

[Solution] A magnetic power transmission system is comprised of an outer rotor 11 including a plurality of left and right permanent magnets 11c arranged in a circumferential direction, an inner rotor 12 including a plurality of left and right permanent magnets 12c arranged in the circumferential direction, and an intermediate rotor 13 including a plurality of left and right soft magnetic material elements 13d and 13e arranged in the circumferential direction. When each of the left and right permanent magnets 11c and 11c, and each permanent magnet 12c are in an opposed position opposed to each other, the magnetic pole of the left permanent magnet 11c and the magnetic pole at the left-side portion of the permanent magnet 12c have polarities different from each other, the magnetic pole of the right permanent magnet 11c and the magnetic pole at the right-side portion of the permanent magnet 12c have the same polarity. Further, when one of the soft magnetic material elements 13d and 13e is between two pairs of permanent magnets 11c and 12c, the other is between two permanent magnets 11c and 12c adjacent to each other.

### FIELD OF THE INVENTION

The present invention relates to a magnetic power transmission system for transmitting a driving force between a plurality of members by magnetic forces.

### BACKGROUND ART

Conventionally, as a magnetic power transmission system of this kind, one disclosed in Patent Literature 1 is known. This magnetic power transmission system is comprised of a plurality of magnetic gears and a system body. Each magnetic gear includes a magnetic disk formed of a magnetic material, and an annular magnetic tooth ring mounted to a surface of the magnetic disk using an adhesive, and a rotational shaft press-fitted into a central portion of the magnetic disk. The rotational shaft is rotatably supported by the system body. The magnetic tooth ring is formed by an annular arrangement of a large number of magnetic teeth formed by permanent magnets and each disposed in a flat state, and the magnetic teeth are arranged such that each adjacent two of the magnetic teeth have polarities different from each other. Further, each magnetic tooth has a shape of radiance curve, such as an involute curve.

In the magnetic power transmission system, a pair of magnetic gears are arranged such that surfaces thereof on the magnetic tooth ring side are opposed to each other, and respective portions of the surfaces of the magnetic tooth rings of the magnetic gears overlap with each other with a predetermined distance between the magnetic tooth rings. When a magnetic force acts between the overlapping portions, torque is transmitted between the pair of magnetic gears. Thus, since torque is transmitted by a magnetic force, compared with a magnetic power transmission system configured to transmit torque by mechanical contact, the above magnetic power transmission system is advantageous in that no lubricating structure is necessary, and there is no fear of generation of backlash or dusts at contact portions.

[Patent Literature 1] Japanese Laid-Open Patent Publication (Kokai) No. 2005-114162.

### DISCLOSURE OF THE INVENTION

### Problem to be Solved by the Invention

According to the above-described conventional magnetic power transmission system, torque is transmitted between a pair of the magnetic gears by a magnetic force acting on an overlapping portion of the magnetic tooth rings, so that a ratio of a portion of a surface of each magnetic tooth ring, contributing to torque transmission, to the gross area of the surface of the magnetic tooth ring is small, thereby making it impossible to ensure the area of a magnetic path efficiently. This results in low transmission efficiency and small transmission torque capacity. Furthermore, the magnetic teeth have such a complicated shape as makes manufacturing of the same troublesome and time-consuming, which increases manufacturing cost of the magnetic power transmission system.

The present invention has been made to provide a solution to the above-described problems, and an object thereof is to provide a magnetic power transmission system which is capable of enhancing power transmission efficiency and power transmission capacity and reducing manufacturing costs of the system, while maintaining the advantageous effects obtained by performing power transmission by magnetic forces.

### Means for Solving the Problems

To attain the object, the invention as claimed in claim 1 provides a magnetic power transmission system 1, 1B to 1H, comprising a first movable member (outer rotor 11, inner rotor 12, left and right outer rotors 21, left and right inner rotors 22, small-diameter rotor 31, large-diameter rotor 32, left rotor 41, right rotor 42, outer slider 51, inner slider 52) including a first magnetic pole row which is formed by a plurality of first magnetic poles (e.g. permanent magnets 11c, 12c, 21c, 22c, 31c, 32c, 41c, 42c, 51c, 52c in the embodiment (the same applies hereinafter in this section)) arranged at approximately equal intervals in a predetermined direction, each two adjacent ones of the first magnetic poles having polarities different from each other, the first movable member being movable along the predetermined direction, a second movable member (outer rotor 11, inner rotor 12, left and right outer rotors 21, left and right inner rotors 22, small-diameter rotor 31, large-diameter rotor 32, left rotor 41, right rotor 42, outer slider 51, inner slider 52) including a second magnetic pole row which is formed by a plurality of second magnetic poles (permanent magnets 11c, 12c, 21c, 22c, 31c, 32c, 41c, 42c, 51c, 52c) arranged at approximately equal intervals in the predetermined direction, each two adjacent ones of the second magnetic poles having polarities different from each other, and is arranged in a manner opposed to the first magnetic pole row, the second movable member being relatively movable with respect to the first movable member along the predetermined direction, a third movable member (outer rotor 11, inner rotor 12, left and right outer rotors 21, left and right inner rotors 22, small-diameter rotor 31, large-diameter rotor 32, left rotor 41, right rotor 42, outer slider 51, inner slider 52) including a third magnetic pole row which is formed by a plurality of third magnetic poles (permanent magnets 11c, 12c, 21c, 22c, 31c, 32c, 41c, 42c, 51c, 52c) arranged at approximately equal intervals in the predetermined direction, each two adjacent ones of the third magnetic poles having polarities different from each other, the third movable member moving relative to the first movable member in an interlocked manner to thereby move along the predetermined direction, a fourth movable member (outer rotor 11, inner rotor 12, left and right outer rotors 21, left and right inner rotors 22, small-diameter rotor 31, large-diameter rotor 32, left rotor 41, right rotor 42, outer slider 51, inner slider 52) including a fourth magnetic pole row which is formed by a plurality of fourth magnetic poles (permanent magnets 11c, 12c, 21c, 22c, 31c, 32c, 41c, 42c, 51c, 52c) arranged at approximately equal intervals in the predetermined direction, each two adjacent ones of the fourth magnetic poles having polarities different from each other, and is arranged in a manner opposed to the third magnetic pole row, and moving relative to the second movable member in an interlocked manner along the predetermined direction, a fifth movable member (intermediate rotor 13, left and right intermediate rotors 23, intermediate-diameter rotor 33, intermediate rotor 43, intermediate slider 53) including a first soft magnetic material element row which is formed by a plurality of first soft magnetic material elements (left soft magnetic material elements 13d, 23d, 33d, 53d, and outer soft magnetic material elements 43d, or right soft magnetic material elements 13e, 23e, 33e, 53e, and inner soft magnetic material elements 43e) arranged at approximately equal intervals in the predetermined direction, and is arranged between the first magnetic pole row and the second magnetic pole row, the fifth movable member being arranged in a manner relatively movable with respect to the first movable member and the second movable member along the predetermined direction, and a sixth movable member (intermediate rotor 13, left and right intermediate rotors 23, intermediate-diameter rotor 33, intermediate rotor 43, intermediate slider 53) including a second soft magnetic material element row which is formed by a plurality of second soft magnetic material elements (right soft magnetic material elements 13e, 23e, 33e, 53e, and inner soft magnetic material elements 43e, or left soft magnetic material elements 13d, 23d, 33d, 53d, and outer soft magnetic material elements 43d) arranged at approximately equal intervals in the predetermined direction, and is arranged between the third magnetic pole row and the fourth magnetic pole row, the sixth movable member moving relative to the fifth movable member in an interlocked manner along the predetermined direction, wherein when each the first magnetic pole and each the second magnetic pole are in a first opposed position opposed to each other, each the third magnetic pole and each the fourth magnetic pole are in a second opposed position opposed to each other; when each the first magnetic pole and each the second magnetic pole in the first opposed position have polarities different from each other, each the third magnetic pole and each the fourth magnetic pole in the second opposed position have polarities identical to each other; when each the first magnetic pole and each the second magnetic pole in the first opposed position have polarities identical to each other, each the third magnetic pole and each the fourth magnetic pole in the second opposed position have polarities different from each other, and wherein when each the first magnetic pole and each the second magnetic pole are in the first opposed position, if each the first soft magnetic material element is in a position between the first magnetic pole and the second magnetic pole, each the second soft magnetic material element is in a position between two pairs of third magnetic poles and fourth magnetic poles adjacent to each other in the predetermined direction, and if each the second soft magnetic material element is in a position between the third magnetic pole and the fourth magnetic pole, each the first soft magnetic material element is in a position between two pairs of first magnetic poles and second magnetic poles which are adjacent to each other in the predetermined direction.

According to this magnetic power transmission system, the second movable member is formed such that it is relatively movable with respect to the first movable member along the predetermined direction; the fifth movable member is formed such that it is relatively movable with respect to the first and second movable members along the predetermined direction; the fourth movable member is formed such that it is relatively movable with respect to the third movable member along the predetermined direction; and the sixth movable member is formed such that it is relatively movable with respect to the third and fourth movable members along the predetermined direction. Furthermore, the third and fourth movable members move relative to the first and second movable members, respectively, in an interlocked manner, and the sixth movable member moves relative to the fifth movable member in an interlocked manner, and therefore if any one of the first to sixth movable members is fixed to a predetermined member other than the first to sixth movable members, configured to be immovable, an interlocked one of the movable member interlocked with the fixed movable member is also immovably fixed (it should be noted that throughout the specification, “to move along the predetermined direction” is intended to mean to move along the predetermined direction in one direction thereof and in a direction opposite to the one direction, as “to move along the left-right direction” means to move in both the left and right directions. Further, “the third movable member moves relative to the first movable member in an interlocked manner” is intended to mean that the first movable member and the third movable member are in a relationship in which they move in an interlocked manner)

First, a description will be given of a case where the first movable member is fixed, and the driving force is input to the second movable member, whereby the second movable member is moved e.g. along the predetermined direction in one direction thereof. In this case, the first movable member is fixed to also fix the third movable member interlocked therewith, and in a manner interlocked with the second movable member, the fourth movable member as well moves. Before the start of the motion of the second and fourth movable members, in a state where each first magnetic pole and each second magnetic pole have polarities different from each other, when each first soft magnetic element is between the first magnetic pole and the second magnetic pole, the magnetic lines of force (hereinafter referred to as “the first magnetic force lines”) are generated between the first magnetic poles, the first soft magnetic material elements, and the second magnetic poles, and the length of each first magnetic force line becomes shortest, and the total magnetic flux amounts thereof become largest.

On the other hand, in the state where the first soft magnetic element is between the first magnetic pole and the second magnetic pole, each third magnetic pole and each fourth magnetic pole in the second opposed position have the same polarity, and each second soft magnetic material element is in a position between two pairs of third magnetic poles and fourth magnetic poles adjacent to each other in the predetermined direction, so that the magnetic lines of force (hereinafter referred to as “the second magnetic force lines”) generated between the third magnetic poles, the second soft magnetic material elements, and the fourth magnetic poles have a large degree of bend thereof, approximately the maximum length, and approximately the minimum total magnetic flux amounts (it should be noted that throughout the present specification, “when the first magnetic pole(s) and the second magnetic pole(s) are in a position opposed to each other” is not intended to mean that the two are in completely the same position in the predetermined direction, but to also mean that they are in respective locations slightly different from each other).

From the above state, when the second movable member starts to be moved in one direction by the driving force, the degree of bend of the first magnetic force line increases. In general, the magnetic lines of force have a characteristic that when bent, they generates a magnetic force acting to shorten the length thereof, and therefore when the first magnetic force lines are bent as described above, a magnetic force acting on the first soft magnetic material element becomes larger as the degree of bend of the first magnetic force line is larger, and as the total magnetic flux amounts thereof are larger. More specifically, the magnetic force acting on the first soft magnetic material element has a characteristic that it is determined depending on the synergistic action of the degree of bend of the first magnetic force line and the total magnetic flux amounts thereof.

Therefore, when each first soft magnetic material element starts to move from between each first magnetic pole and each second magnetic pole, the length of the first magnetic force line becomes shorter; the total magnetic flux amounts thereof becomes larger; and the first magnetic force line starts to be bent, so that a strong magnetic force acts on the first soft magnetic material element by the synergistic action of the degree of bend of the first magnetic force line and the total magnetic flux amounts thereof, whereby the fifth movable member is driven in the same direction as the moving direction of the second movable member. On the other hand, when the second movable member starts to move as described above, the fourth movable member moves in a manner interlocked with the second movable member, whereby each fourth magnetic pole moves away from the second opposed position in which it is opposed to each third magnetic pole having the same polarity, to move toward each third magnetic pole which is adjacent to the third magnetic pole having the same polarity, and has a polarity different from that of the fourth magnetic pole. In accordance with this motion, second magnetic force lines are generated between the third magnetic poles, the second soft magnetic material elements, and the fourth magnetic poles. Although the degree of bend of the second magnetic force lines is large, the total magnetic flux amounts thereof is small, so that a relatively weak magnetic force acts on the second movable member by the synergistic action thereof. This drives the six movable member in the same direction as the moving direction of the fourth movable member.

Then, when the second movable member further moves, although the degree of bend of the first magnetic force lines increases, the total magnetic flux amounts thereof decreases, and magnetic forces acting on the first soft magnetic material elements decreases by the synergistic action thereof to decrease the driving force of the fifth movable member. When each first magnetic pole moves to the first opposed position opposed to each second magnetic pole having the same polarity, each first soft magnetic material element is between two pairs of first magnetic poles and second magnetic poles adjacent to each other in the predetermined direction. Accordingly, although the degree of bend of the first magnetic force lines is large, the total magnetic flux amounts thereof becomes approximately minimum, and the synergistic action thereof makes the magnetic force acting on the first soft magnetic material element approximately weakest, and the driving force acting on the fifth movable member approximately smallest.

On the other hand, when the second movable member moves as described above, the fourth movable member moves in a manner interlocked with second movable member, and each fourth magnetic pole moves such that it becomes closer to each third magnetic pole having a different polarity, whereby the total magnetic flux amounts of the second magnetic force lines increases although the degree of bend of the same decreases, and by the synergistic action thereof, the magnetic force acting on the second soft magnetic material element increases to increase the driving force of the sixth movable member. When each third magnetic pole moves to a location in the vicinity of the second opposed position in which it is opposed to each fourth magnetic pole having a polarity different from the polarity thereof, the total magnetic flux amounts of the second magnetic force lines is maximized, and the second soft magnetic material element follows the fourth magnetic pole with a slight motion delay, to thereby bend the second magnetic force lines. As a result, the synergistic action thereof makes the magnetic force acting on the second soft magnetic material element approximately strongest, and the driving force acting on the sixth movable member approximately largest.

As described above, when the second movable member further moves in one direction from the state in which the driving force acting on the fifth movable member is almost minimum, and at the same time the driving force acting on the sixth movable member is almost maximum, inversely to the above, the first magnetic force lines decreases in the degree of bend thereof, and increases in the total magnetic flux amounts thereof, and the synergistic action thereof makes stronger the magnetic force acting on the first soft magnetic material element to increase the driving force of the fifth movable member. On the other hand, the second magnetic force lines increases in the degree of bend thereof, and decreases in the total magnetic flux amounts thereof, and the synergistic action thereof weakens the magnetic force acting on the second soft magnetic material element, and lowers the driving force of the sixth movable member.

As described above, along with the motion of the second movable member, a state is repeated in which the driving force acting on the fifth movable member and the driving force acting on the sixth movable member alternately increase and decrease, whereby the fifth and sixth movable members are driven, so that it is possible to transmit the driving force input to the second movable member to the fifth and sixth movable members. Further, the fourth movable member is formed such that it moves relative to the second movable member in an interlocked manner, and hence even when the driving force is input to the fourth movable member, the driving force can be transmitted to the fifth and sixth movable members, as described above.

Furthermore, each first soft magnetic material element is configured such that while each second magnetic pole of the second movable member moves from the first opposed position opposed to each first magnetic pole having a polarity different from the polarity thereof to the first opposed position opposed to each first magnetic pole having the same polarity, the first soft magnetic material element moves from the first opposed position to a position between two pairs of first magnetic poles and second magnetic poles adjacent to each other in the predetermined direction. Therefore, the fifth movable member moves in a state more decelerated than the second movable member. Similarly, each second soft magnetic material element is configured such that while each fourth magnetic pole of the fourth movable member moves from the second opposed position in which it is opposed to each third magnetic pole having a polarity different from the polarity thereof, to the second opposed position in which it is opposed to each third magnetic pole which is adjacent to the above third magnetic pole, and has the same polarity, the second soft magnetic material element moves from the second opposed position to a position between two pairs of third magnetic poles and fourth magnetic poles adjacent to each other in the predetermined direction. Therefore, the sixth movable member moves in a state more decelerated than the fourth movable member. That is, the driving force input to the second movable member or the fourth movable member can be transmitted to the fifth and sixth in a decelerated state.

Next, a description will be given of a case where inversely to the above, the second movable member is fixed, and the driving force is input to the first movable member. In this case, for the aforementioned reason, the fourth movable member as well is fixed, and the first movable member is driven for motion by the driving force, to move the third movable member as well in a manner interlocked with the motion of the first movable member. Then, along with the motions of the first movable member and the third movable member, as described above, the state is repeated in which the driving force acting on the fifth movable member and the driving force acting on the sixth movable member alternately increase and decrease, whereby the fifth and sixth movable members are driven. As a result, the driving force input to the first movable member can be transmitted to the fifth and sixth movable members. Further, as described hereinabove, the fifth movable member is more decelerated than the first movable member, and the sixth movable member as well is more decelerated than the third movable member, so that the driving force input to the first movable member or the third movable member can be transmitted to the fifth and sixth movable members in a decelerated state.

Then, a description will be given of a case where the fifth movable member is fixed, and the driving force is input to the first movable member. In this case, for the aforementioned reason, the sixth movable member as well is fixed, and the third movable member as well moves in a manner interlocked with the motion of the first movable member. Before the start of the motion of the first movable member, when each first magnetic pole and each second magnetic pole having polarities identical to each other are in the first opposed position, and each first soft magnetic material element is in a position between two pairs of first magnetic poles and second magnetic poles adjacent to each other, as described above, the degree of bend of the first magnetic force lines becomes large, the length thereof approximately maximum, and the total magnetic flux amounts thereof approximately minimum.

From this state, when the first movable member starts to move along the predetermined direction in one direction, the first magnetic pole of the first movable member starts to move such that it becomes closer to the first soft magnetic material element, and at the same time becomes closer to the second magnetic pole of the second movable member having a polarity different from that of the first magnetic pole, adjacent to the second magnetic pole of the second movable member having the same magnetic pole. In accordance with the motion of the first magnetic pole, the first magnetic force line is changed such that the length thereof is reduced, whereby the total magnetic flux amount thereof increases, and the degree of bend thereof becomes considerably larger. As a result, a relatively strong magnetic force acts on the second magnetic pole by the synergistic action of the degree of bend of the first magnetic force line and the total magnetic flux amount thereof, whereby the second movable member is driven such that it becomes closer to the first movable member. In a manner interlocked with this, the fourth movable member as well is driven such that it becomes closer to the third movable member. That is, the second movable member is driven in a direction opposite to the moving direction of the first movable member, and at the same time the fourth movable member as well is driven in a direction opposite to the moving direction of the third movable member.

Then, as the first magnetic pole becomes still closer to the first soft magnetic material element, the second magnetic pole also moves such that it becomes closer to the first soft magnetic material element, due to a magnetic force generated by the first magnetic force line. When the first magnetic pole moves to a position in which it becomes closest to the first soft magnetic material element, the first magnetic pole is brought to the first opposed position in which it is opposed to the first magnetic pole different in polarity with the first soft magnetic material element positioned therebetween. In this state, the second soft magnetic material element is in a position between two pairs of third magnetic poles and fourth magnetic poles adjacent to each other.

From this state, when the first movable member further moves, each third magnetic pole of the third movable member becomes closer to the second soft magnetic material element, and at the same time moves such that it becomes closer to the fourth magnetic pole of the fourth movable member having a polarity different from that of the third magnetic pole, adjacent to the fourth magnetic pole of the fourth movable member having the same magnetic pole. In accordance with the motion of the third magnetic pole, the second magnetic force line is changed such that the length thereof is reduced, whereby the total magnetic flux amount thereof increases, and the degree of bend thereof becomes considerably larger. As a result, a relatively strong magnetic force acts on the fourth magnetic pole by the synergistic action of the degree of bend of the second magnetic force line and the total magnetic flux amount thereof, whereby the fourth movable member is driven such that it becomes closer to the third movable member. In a manner interlocked with this, the second movable member is also driven such that it becomes closer to the first movable member. That is, the fourth movable member is driven in a direction opposite to the moving direction of the third movable member, and at the same time the second movable member is also driven in a direction opposite to the moving direction of the first movable member.

As described above, along with the motions of the first and third movable members, a state is repeated in which driving forces alternately act on the second movable member and the fourth movable member, whereby the second and the fourth movable members are driven in directions opposite to the moving directions of the first movable member and the third movable member, respectively, so that it is possible to transmit a driving force input to the first movable member to the second movable member and the fourth movable member. Further, the third movable member is formed such that it moves relative to the first movable member in an interlocked manner, and therefore even when a driving force is input to the third movable member, the driving force can be transmitted to the second movable member and the fourth movable member. Furthermore, when each first magnetic pole of the first movable member moves from a position in which it is opposed to each second magnetic pole having a polarity different from its polarity to a position in which it is opposed to each second magnetic pole having the same polarity with the first soft magnetic material element positioned therebetween, the second magnetic pole of the second movable member also moves the same distance as the distance over which the first magnetic pole moves. Therefore, the first movable member and the second movable member move at the same speed, and along with the motions thereof, the third movable member and the fourth movable member also move at the same speed, so that it is possible to transmit the driving force input to the first movable member to the fourth movable member at a constant speed.

As described hereinabove, according to the magnetic power transmission system, when any one of the first to sixth movable members is fixed, to input a driving force to another thereof not interlocked with the one movable member, for example, when the first movable member is fixed, to input a driving force to the second movable member, the driving force can be transmitted to the fifth and sixth movable members by magnet forces. In doing this, magnetic paths can be formed using all the first soft magnetic material elements of the fifth movable member, all the second soft magnetic material elements of the sixth movable member, and the first to fourth magnetic poles of the first to fourth movable members, which generate magnetic lines of force between the soft magnetic material elements, and therefore compared with the conventional magnetic power transmission system which forms magnetic paths using only part of magnetic poles, it is possible to enhance power transmission efficiency and power transmission capacity, while maintaining the advantageous effects obtained by performing power transmission with magnetic forces.

On the other hand, also when a driving force is input to the fifth movable member or the sixth movable member in a state in which none of the first to sixth movable members is fixed, by using the above-described action of the magnetic lines of force, it is possible to transmit the driving force to the first magnetic poles of the first movable member and the second magnetic poles of the second movable member via the first soft magnetic material elements, and transmit the driving force to the third magnetic poles of the third movable member and the fourth magnetic poles of the fourth movable member via the second soft magnetic material elements. More specifically, the driving force input to the fifth movable member or the sixth movable member can be transmitted by dividing the driving force into two other parts including part to be transmitted to the first movable member or the third movable member, and part to be transmitted to the second movable member or the fourth movable member. In this case as well, as described above, magnetic paths can be formed using all the first soft magnetic material elements of the fifth movable member, all the second soft magnetic material elements of the sixth movable member, and the first to fourth magnetic poles of the first to fourth movable members, which generate magnetic lines of force between the soft magnetic material elements, and therefore compared with the conventional magnetic power transmission system which forms magnetic paths using only part of magnetic poles, it is possible to enhance power transmission efficiency and power transmission capacity.

Additionally, also when a driving force is input to the first movable member and the second movable member in the state in which none of the first to sixth movable members is fixed, by using the above-described action of the magnetic lines of force, it is possible to transmit the driving force to the first soft magnetic material elements via the first magnetic poles of the first movable member and the second magnetic poles of the second movable member, and transmit the driving force to the second soft magnetic material elements via the third magnetic poles of the third movable member and the fourth magnetic poles of the fourth movable member. More specifically, the resultant force of the driving forces input to the first movable member and the second movable member, respectively, can be transmitted to the fifth movable member or the sixth movable member. Also in doing this, fir the above-described reason, it is possible to enhance power transmission efficiency and power transmission capacity.

The invention as claimed in claim 2 is a magnetic power transmission system 1, 1C to 1H as claimed in claim 1, wherein the first movable member and the third movable member are integrally formed with each other as a seventh movable member (outer rotor 11 or inner rotor 12, small-diameter rotor 31 or large-diameter rotor 32, left rotor 41 or right rotor 42, outer slider 51 or inner slider 52), the second movable member and the fourth movable member being integrally formed with each other as an eighth movable member (inner rotor 12 or outer rotor 11, large-diameter rotor 32 or small-diameter rotor 31, right rotor 42 or left rotor 41, inner slider 52 or outer slider 51), the fifth movable member and the sixth movable member being integrally formed with each other as a ninth movable member (intermediate rotor 13, intermediate-diameter rotor 33, intermediate rotor 43, intermediate slider 53).

According to this magnetic power transmission system, it is possible to realize a system having the aforementioned advantageous effects by three movable members. Therefore, compared with the case in which the six movable members are used, the number of component parts can be reduced, thereby making it possible to reduce manufacturing costs of the system.

The invention as claimed in claim 3 is a magnetic power transmission system 1H as claimed in claim 2, wherein the seventh to ninth movable members are formed by three sliders (outer slider 51, inner slider 53, intermediate slider 53) relatively slidable with respect to each other, respectively.

According to this magnetic power transmission system, it is possible to transmit a driving force input to one of the sliders to one or both of the other two sliders by magnetic forces, thereby making it possible to realize a magnetic power transmission system for performing linear power transmission.

The invention as claimed in claim 4 is a magnetic power transmission system 1, 1C to 1G as claimed in claim 2, wherein the seventh to ninth movable members are formed by three concentric rotors (outer rotor 11, inner rotor 12, intermediate rotor 13, small-diameter rotor 31, large-diameter rotor 32, intermediate-diameter rotor 33, left rotor 41, right rotor 42, intermediate rotor 43) relatively rotatable with respect to each other, respectively, the plurality of first to fourth magnetic poles and the plurality of first and second soft magnetic material elements being set to be equal in number to each other.

According to this magnetic power transmission system, torque input to one rotor can be transmitted to one or both of the other two rotors by magnetic forces, whereby it is possible to realize a magnetic power transmission system for performing torque transmission. Further, since the plurality of first to fourth magnetic poles and the plurality of first and second soft magnetic material elements are set to be equal in number to each other, it is possible to form magnetic paths by efficiently using all the opposed surfaces of the magnetic poles and the soft magnetic material elements, thereby making it possible to ensure the areas of magnetic paths for passing magnetic lines of force more efficiently. As a result, it is possible to further enhance torque transmission efficiency and torque transmission capacity.

The invention as claimed in claim 5 is a magnetic power transmission system 1, 1C to 1H as claimed in any one of claims 2 to 4, wherein one of the seventh to ninth movable members (outer rotor 11, inner rotor 12, intermediate rotor 13, small-diameter rotor 31, large-diameter rotor 32, intermediate-diameter rotor 33, left rotor 41, right rotor 42, intermediate rotor 43, outer slider 51, inner slider 52, intermediate slider 53) is configured to be immovable.

According to this magnetic power transmission system, when the seventh movable member or the eighth movable member is configured to be immovable, as described above, it is possible to transmit a driving force input to the eighth movable member or the seventh movable member to the ninth movable member in a decelerated state, and transmit a driving force input to the ninth movable member to the eighth movable member or the seventh movable member in an accelerated state. Further, when the ninth movable member is configured to be immovable, as described above, it is possible to transmit the driving force input to the eighth movable member or the seventh movable member to the seventh movable member or the eighth movable member as a driving force in a direction opposite to the direction of the input driving force.

The invention as claimed in claim 6 is a magnetic power transmission system 1C to 1E as claimed in any one of claims 2 to 5, further comprising a magnetic force-changing device (actuator 17, short-circuit member 18) for changing magnetic forces acting on the seventh to ninth movable members (outer rotor 11, inner rotor 12, intermediate rotor 13).

According to this magnetic power transmission system, the magnetic forces acting on the seventh to ninth movable members are changed by the magnetic force-changing device, and hence it is possible to change the capability of transmitting a driving force between the seventh to ninth movable members.

### BEST MODE FOR CARRYING OUT THE INVENTION

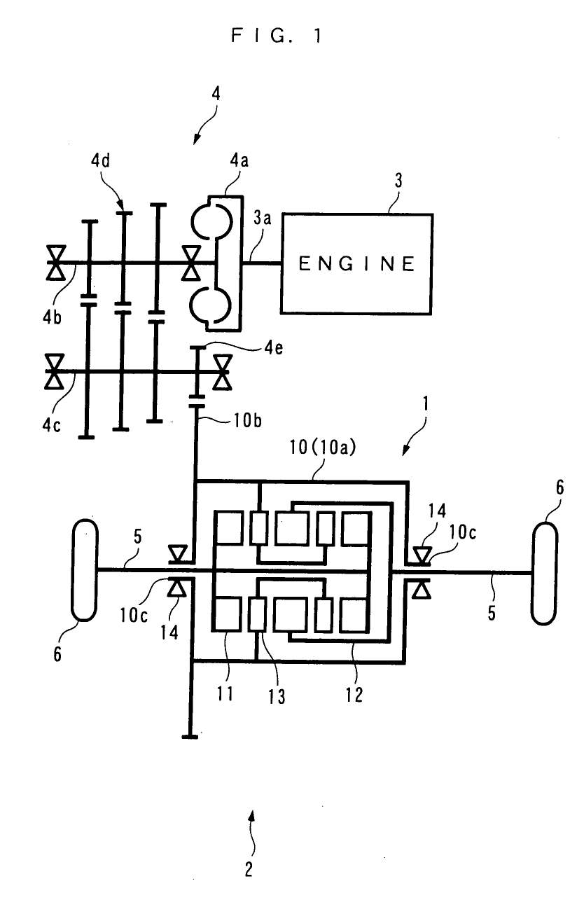

Hereafter, a magnetic power transmission system according a first embodiment of the present invention, will be described with reference to the drawings. The first embodiment is an example in which the magnetic power transmission system of the present invention is applied to a differential unit of a vehicle drive system. FIG. 1 schematically shows the magnetic power transmission system 1 according the present embodiment, and the drive system for a vehicle 2, equipped therewith. As shown in the figure, the vehicle 2 includes an engine 3, an automatic transmission 4, the magnetic power transmission system 1, left and right drive shafts 5 and 5, and left and right drive wheels 6 and 6.

In the vehicle 2, torque of the engine 3 is changed in speed by the automatic transmission 4, and then transmitted to the left and right drive wheels 6 and 6 via the magnetic power transmission system 1, and the left and right drive shafts 5 and 5, respectively.

The automatic transmission 4 includes a torque converter 4a connected to a crankshaft 3a of the engine 3, a main shaft 4b integrally formed with an output shaft of the torque converter 4a, an auxiliary shaft 4c parallel to the main shaft 4b, a gear mechanism 4d having a plurality of gear positions formed by a plurality of gear pairs (only one of which is shown) arranged on the shafts 4b and 4c, an output gear 4e disposed on the auxiliary shaft 4c, a clutch mechanism (not shown) for selectively switching the gear positions of the gear mechanism 4d, ands so forth.

In the automatic transmission 4, the gear positions of the gear mechanism 4d are selectively switched according to a speed change command from a control system, not shown, and torque transmitted from the engine 3 via the torque converter 4a is changed to a rotational speed dependent of the gear position of the gear mechanism 4d to be transmitted to the magnetic power transmission system 1 via the output gear 4e.

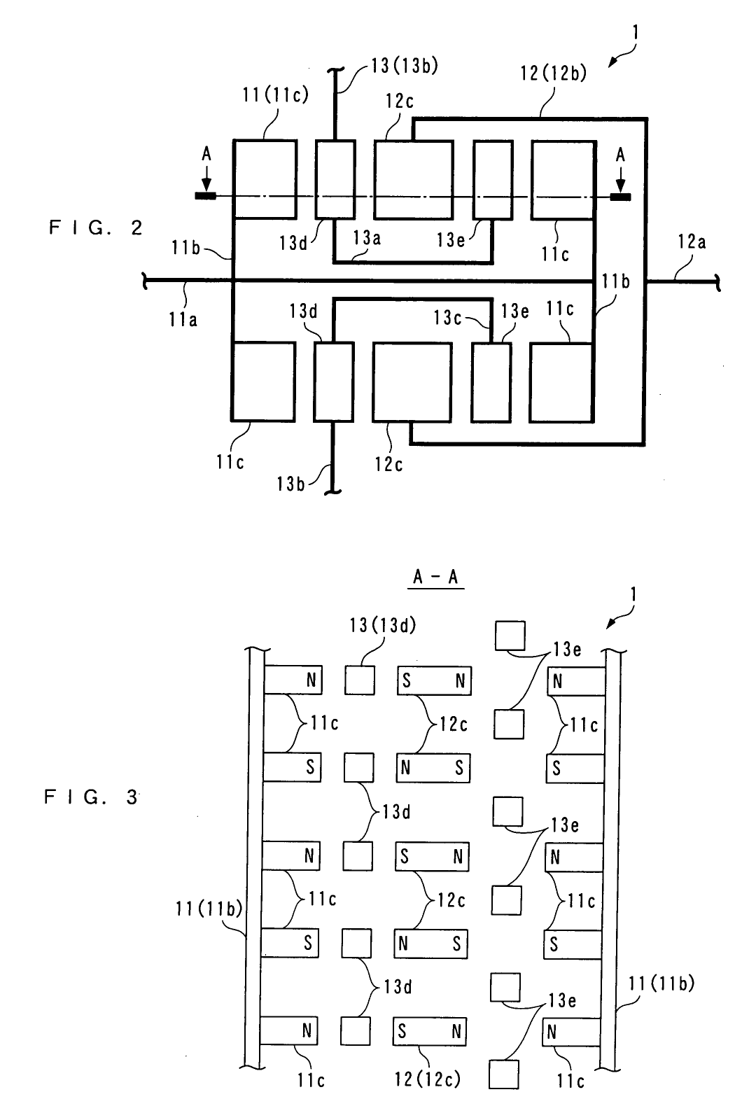

Next, a description will be given of the magnetic power transmission system 1. FIG. 2 is a schematic diagram of essential components of the magnetic power transmission system 1, and FIG. 3 is a planar development view of part of a cross-section of the magnetic power transmission system 1 taken on line A-A of FIG. 2 along a circumferential direction. It should be noted that in FIG. 3, hatching in portions illustrating cross-sections are omitted for ease of understanding. Further, in the following description, the left side and the right side as viewed in the figures will be referred to as “the left” and “the right”.

As shown in FIGS. 1 and 2, the magnetic power transmission system 1 includes a casing 10, an outer rotor 11, an inner rotor 12, and an intermediate rotor 13. The casing 10 includes a hollow cylindrical body 10a, a gear 10b, and shafts 10c and 10c, which are integrally formed with the body 10a. The gear 10b is formed in manner extending outward from an outer peripheral surface of the body 10a, in constant mesh with the output gear 4e of the automatic transmission 4. Thus, in accordance with rotation of the output gear 4e of the automatic transmission 4, the casing 10 as well rotates. Further, the shafts 10c and 10c, having a hollow cylindrical shape, extend from the left and right side surfaces of the body 10, and are rotatably supported by two bearings 14 and 14.

On the other hand, the outer rotor 11 includes a rotational shaft 11a, and a pair of left and right disks 11b and 11b concentrically formed on the rotational shaft 11a. The rotational shaft 11a is concentric with the shafts 10c of the casing 10, for extending through inner holes thereof, and its left end is connected to the drive shaft 5. Further, the right disk 11b is fixed to the right end of the rotational shaft 11a, and the left disk 11b is fixed to a predetermined portion of the rotational shaft 11a with a predetermined distance between the same and the right disk 11b.

The left and right disks 11b and 11b are each made of a soft magnetic material element, and on opposed surfaces thereof, left and right permanent magnet rows are formed in plane symmetry with each other at respective locations closer to outer peripheral ends of the surfaces. The left and right permanent magnet rows are each comprised of m (m is an integer) permanent magnets 11c, and the permanent magnets 11c are mounted to the disks 11b in a state in which the permanent magnets 11c and 11c opposed to each other are arranged to have the same polarities. Further, in each permanent magnet row, the m permanent magnets 11c are arranged at predetermined equal intervals such that the magnetic poles of each adjacent two of the permanent magnets 11c and 11c have polarities different from each other.

Further, the inner rotor 12 includes a rotational shaft 12a concentric with the rotational shaft 11a of the outer rotor 11, and a hollow cylindrical casing portion 12b concentrically and integrally formed with the rotational shaft 12a. The rotational shaft 12a has a right end connected to the drive shaft 5. Further, the casing portion 12b has a left end formed with a permanent magnet row disposed in the center of the two permanent magnet rows of the outer rotor 11 in a manner opposed thereto. This permanent magnet row is formed of m permanent magnets 12c.

The permanent magnets 12c are mounted to the casing portion 12b in a state in which they are arranged such that polarities on the left and right sides of each adjacent two of the permanent magnets 12c and 12c are different from each other. Further, the m permanent magnets 12c are provided such that they are in plane symmetry with the above-described m permanent magnets 11c when the outer rotor 11 and the inner rotor 12 have a predetermined rotational position relationship therebetween. More specifically, the permanent magnets 12c are arranged such that they are identical to the permanent magnets 11c in number, pitch, and the radial distance from the center of rotation. Furthermore, the opposite side surfaces of each permanent magnet 12c have approximately the same area and shape as those of an end face of each permanent magnet 11c opposed thereto.

It should be noted that in the present embodiment, one of the outer rotor 11 and the inner rotor 12 corresponds to first, third, and seventh movable members, and the other to second, fourth, and eighth movable members. Further, either of the left and right permanent magnets 11c, and the permanent magnets 12c correspond to first and third magnetic poles, and the other to second and fourth magnetic poles.

Furthermore, the intermediate rotor 13 rotates in unison with the casing 10, and includes a hollow cylindrical portion 13a rotatably fitted in the rotational shaft 11a, a left wall 13b radially extending from the left end of the hollow cylindrical portion 13a for being continuous with the inner wall of the casing 10, and a right wall 13c integrally formed with the right end of the hollow cylindrical portion 13a.

A left soft magnetic material element row is provided at a predetermined portion of the left wall 13b such that it is at the center between the left permanent magnet row of the outer rotor 11 and the permanent magnet row of the inner rotor 12 in a manner opposed thereto. The left soft magnetic material element row is comprised of m left soft magnetic material elements (e.g. laminates of steel plates) 13d, and the left soft magnetic material elements 13d are mounted to the left wall 13b such that they are in plane-symmetric relation with the above-described permanent magnets 11c or the permanent magnets 12c when the intermediate rotor 13 is in a predetermined rotational position relationship with the outer rotor 11 or the inner rotor 12. More specifically, the left soft magnetic material elements 13d are arranged such that they are identical to the permanent magnets 11c and the permanent magnets 12c in number, pitch, and the radial distance from the center of rotation. Furthermore, the opposite side surfaces of each left soft magnetic material element 13d have approximately the same area and shape as those of the end face of each permanent magnet 11c, and the opposite side surfaces of each permanent magnet 12c.

On the other hand, a right soft magnetic material element row is provided at a foremost end of the right wall 13c such that it is at the center between the right permanent magnet row of the outer rotor 11 and the permanent magnet row of the inner rotor 12 in a manner opposed thereto. The right soft magnetic material element row is formed of m right soft magnetic material elements (e.g. laminates of steel plates) 13e. The right soft magnetic material elements 13e are arranged such that they are identical to the left soft magnetic material elements 13d in pitch and the radial distance from the center of rotation, and mounted to the right wall 13b in a state circumferentially displaced from the left soft magnetic material elements 13d by a half of the pitch (see FIG. 3). Furthermore, similarly to the opposite side surfaces of each left soft magnetic material element 13d, the opposite side surfaces of each right soft magnetic material element 13e have approximately the same area and shape as those of the end face of each permanent magnet 11c, and the opposite side surfaces of each permanent magnet 12c.

Further, the distances between the respective opposite side surfaces of the left soft magnetic material element 13d, and the end face of the left permanent magnet 11c and the left side surface of the permanent magnet 12c, and the distances between the respective opposite side surfaces of the right soft magnetic material element 13e, and the end face of the right permanent magnet 11c and the right side surface of the permanent magnet 12c are set to be equal to each other.

It should be noted that in the present embodiment, the intermediate rotor 13 corresponds to fifth, sixth and ninth movable members, while one of the left and right soft magnetic material elements 13d and 13e corresponds to a first soft magnetic material element, and the other to a second soft magnetic material element.

Furthermore, the above-described casing 10 and three rotors 11 to 13 are supported by a large number of radial bearings and thrust bearings (none of which are shown in the figures), such that they are hardly changed in the mutual positional relationships in the direction of the rotational axis and the radial direction, and configured such that they are relatively rotatable with respect to each other about the same rotational axis.

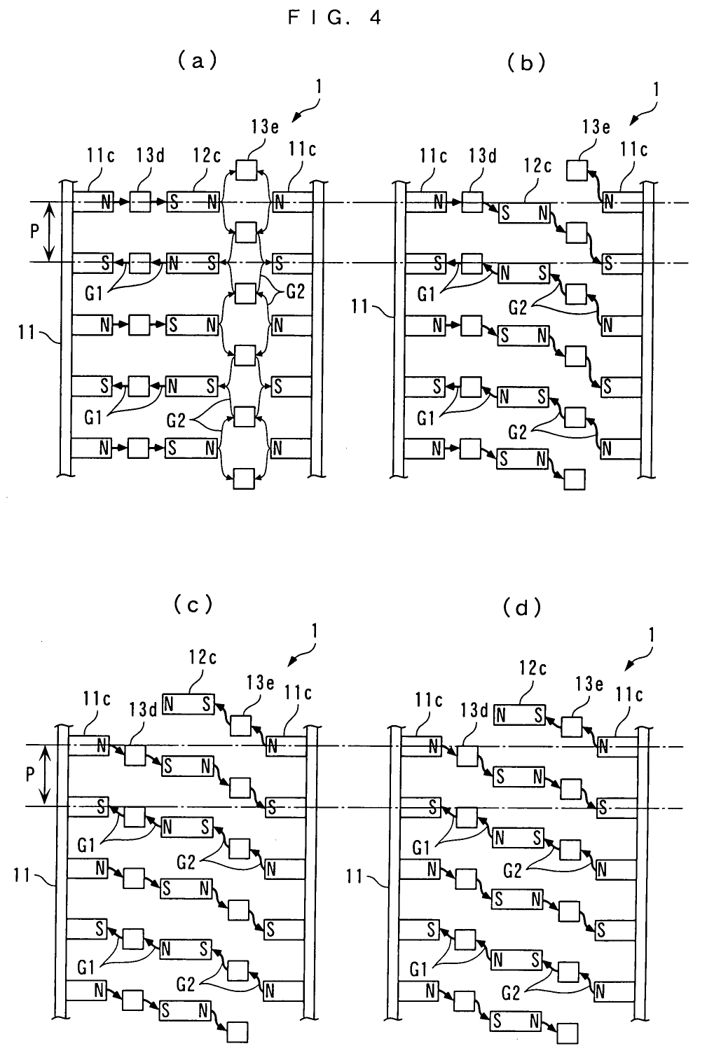

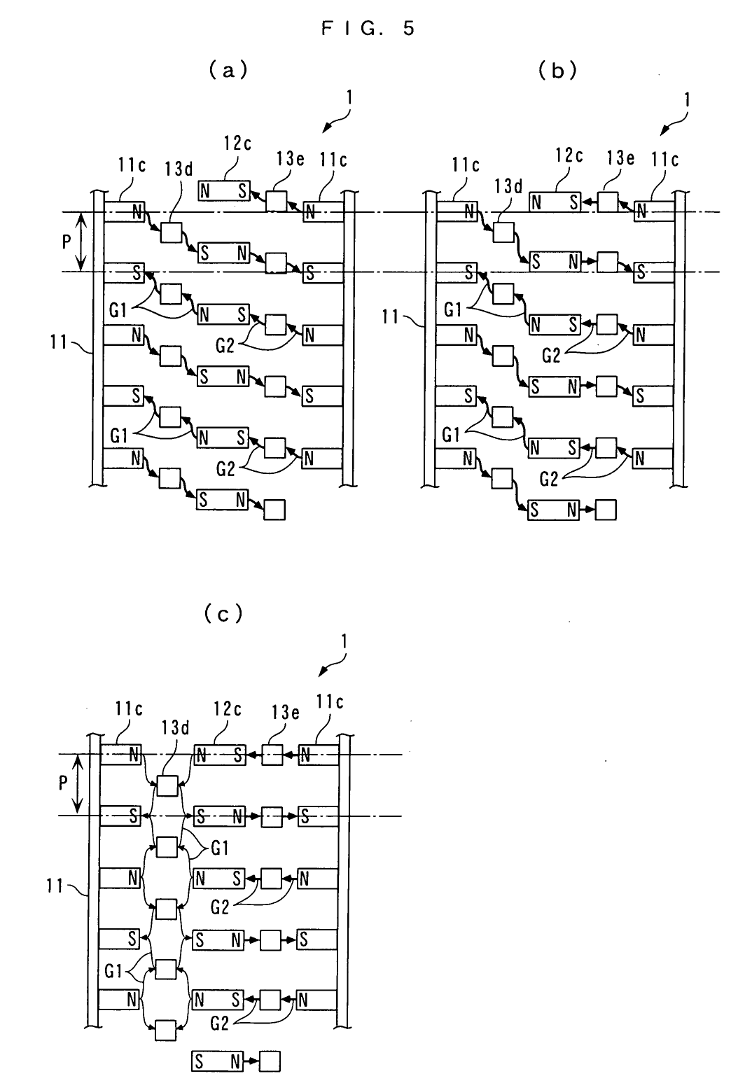

Next, a description will be given of the operation of the magnetic power transmission system 1 configured as above. It should be noted that in the following description, the rotational speeds of the three rotors 11 to 13 are represented by V1 to V3, respectively, and torques of the three rotors 11 to 13 by TRQ1 to TRQ3. First, a case will be described with reference to FIGS. 4 and 5, in which the torque TRQ2 is input to the inner rotor 12 in a state of the outer rotor 11 being unrotatably fixed (V1=0, TRQ1=0), whereby the inner rotor 12 is rotated in a predetermined direction (direction corresponding to downward, as viewed in the figures).

First, before the start of rotation of the inner rotor 12, when the opposite side surfaces of each permanent magnet 12c of the inner rotor 12 are at an opposed position where they are opposed to the respective end faces of the permanent magnets 11c and 11c of the outer rotor 11, due to the above-described arrangement, one of two pairs of magnetic poles opposed to each other have polarities different from each other, and the other have the same polarity. For example, as shown in FIG. 4(a), when a magnetic pole of each left permanent magnet 11c and a magnetic pole at a left-side portion of each permanent magnet 12c have polarities different from each other, if each left soft magnetic material element 13d is in a position between the above magnetic poles, each right soft magnetic material element 13e is positioned at the center between a pair of permanent magnets 11c and 12c located at a right-side opposed position, and a pair of permanent magnets 11c and 12c adjacent to the respective permanent magnets 11c and 12c located at the right-side opposed position.

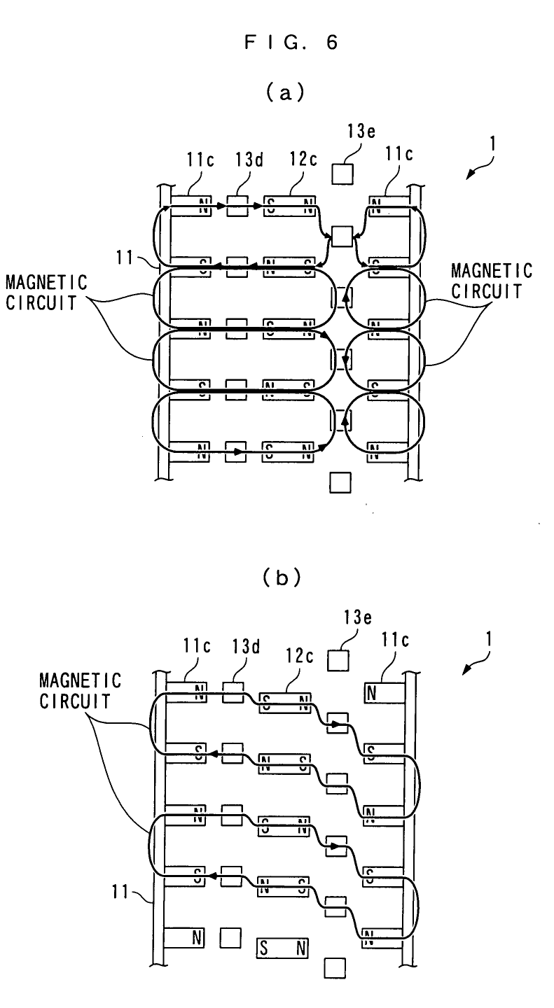

In this state, first magnetic lines G1 of force are generated between the magnetic pole of each left permanent magnet 11c, each left soft magnetic material element 13d, and the magnetic pole at the left-side portion of the permanent magnet 12c, and second magnetic lines G2 of force are generated between the magnetic pole of each right permanent magnet 11c, each right soft magnetic material element 13e, and a magnetic pole at a right-side portion of each permanent magnet 12c, whereby magnetic circuits as shown in FIG. 6(a) are formed.

As described hereinbefore, the magnetic lines of force have a characteristic that when bent, they generate magnetic forces acting to reduce the lengths thereof, and therefore when the first magnetic lines G1 are bent, magnetic forces acting on the left soft magnetic material element 13d becomes larger as the degree of bend of the first magnetic lines G1, and the total magnetic flux amounts thereof are larger. More specifically, the magnetic force acting on the left soft magnetic material elements 13d is determined depending on the synergistic action of the degree of bend of the first magnetic lines G1 and the total magnetic flux amounts thereof. Similarly, also in a case where the second magnetic lines G2 are in a bent state, a magnetic force acting on the right soft magnetic material elements 13e is determined depending on the synergistic action of the degree of bend of the second magnetic lines G2 and the total magnetic flux amounts thereof. Therefore, in states shown in FIGS. 4(a) and 6(b), no magnetic forces that rotate the right soft magnetic material elements 13e upward or downward, as viewed in the figures, are generated by the synergistic action of the degree of bend of the second magnetic lines G2 and the total magnetic flux amounts thereof.

When the inner rotor 12 rotates due to the torque TRQ2 from a position shown in FIG. 4(a) to a position shown in FIG. 4(b), in accordance with the rotation of the inner rotor 12, the second magnetic line G2 that is generated between an N pole of the right permanent magnet 11c, the right soft magnetic material element 13e, and an S pole at a right-side portion of the permanent magnet 12c, or between an S pole of the right permanent magnet 11c, the right soft magnetic material element 13e, and an N pole at the right-side portion of the permanent magnet 12c, is increased in the total magnetic flux amount, and the first magnetic line G1 between the left soft magnetic material element 13d and the magnetic pole at the left-side portion of the permanent magnet 12c is bent. Accordingly, magnetic circuits as shown in FIG. 6(b) are formed by the first magnetic lines G1 and the second magnetic lines G2.

In this state, a considerably strong magnetic force acts on the left soft magnetic material element 13d by the synergistic action of the degree of bend of the first magnetic lines G1 and the total magnetic flux amounts thereof, and drives the left soft magnetic material elements 13d downward, as viewed in FIG. 4, while a relatively weak magnetic force acts on the right soft magnetic material elements 13e by the synergistic action of the degree of bend of the second magnetic lines G2 and the total magnetic flux amounts thereof, and drives the right soft magnetic material elements 13e downward, as viewed in FIG. 4. As a result, the intermediate rotor 13 is driven such that it is rotated in the same direction as the direction of rotation of the inner rotor 12, by the resultant force of the magnetic force acting on the left soft magnetic material elements 13d and the magnetic force acting on the right soft magnetic material elements 13e.

Then, when the inner rotor 12 rotates from the position shown in FIG. 4(b) to respective positions shown in FIGS. 4(c) and 4(d), and FIGS. 5(a) and 5(b) in the mentioned order, each left soft magnetic material element 13d and each right soft magnetic material element 13e are driven downward by magnetic forces generated by the first magnetic lines G1 and the second magnetic lines G2, respectively, whereby the intermediate rotor 13 is rotated in the same direction as the direction of rotation of the inner rotor 12. During the rotation of the intermediate rotor 13, the magnetic force acting on the left soft magnetic material elements 13d is progressively reduced by the synergistic action of the degree of bend of the first magnetic lines G1 and the total magnetic flux amounts thereof, whereas the magnetic force acting on the right soft magnetic material elements 13e is progressively increased by the synergistic action of the degree of bend of the second magnetic lines G2 and the total magnetic flux amounts thereof.

While the inner rotor 12 rotates from the position shown in FIG. 5(b) toward a position shown in FIG. 5(c), each second magnetic line G2 is bent, and the total magnetic flux amounts thereof become almost maximum, such that the strongest magnetic force of the second magnetic line G2 act on the right soft magnetic material element 13e by the synergistic action of the degree of bend of the second magnetic lines G2 and the total magnetic flux amount thereof. After that, as shown in FIG. 5(c), when the inner rotor 12 rotates by one pitch P of the permanent magnet 11c, whereby the permanent magnet 12c is moved to the position where it is opposed to the left and right permanent magnets 11c and 11c, the magnetic pole of the left permanent magnet 11c and the magnetic pole at the left-side portion of the permanent magnet 12c have the same polarity such that the left soft magnetic material element 13d is in a position between the magnetic poles of the two pairs of permanent magnets 11c and 12c having the same polarities, respectively. In this state, no magnetic forces that rotate the left soft magnetic material element 13d downward, as viewed in FIG. 5, are generated by the synergistic action of the degree of bend of the first magnetic lines G1 and the total magnetic flux amount thereof. On the other hand, the magnetic pole of the right permanent magnet 11c and the magnetic pole at the right-side portion of the permanent magnet 12c have polarities different from each other.

From this state, when the inner rotor 12 further rotates, the left soft magnetic material elements 13d are driven downward by a magnetic force generated by the synergistic action of the degree of bend of the first magnetic lines G1 and the total magnetic flux amounts thereof, while the right soft magnetic material elements 13e are driven downward by a magnetic force generated by the synergistic action of the degree of bend of the second magnetic lines G2 and the total magnetic flux amounts thereof, whereby the intermediate rotor 13 is rotated in the same direction as the direction of rotation of the inner rotor 12. In doing this, while the inner rotor 12 rotates to the position shown in FIG. 4(a), inversely to the above, the magnetic force acting on the left soft magnetic material elements 13d are increased by the synergistic action of the degree of bend of the first magnetic lines G1 and the total magnetic flux amounts thereof, whereas the magnetic force acting on the right soft magnetic material elements 13e is decreased by the synergistic action of the degree of bend of the second magnetic lines G2 and the total magnetic flux amounts thereof.

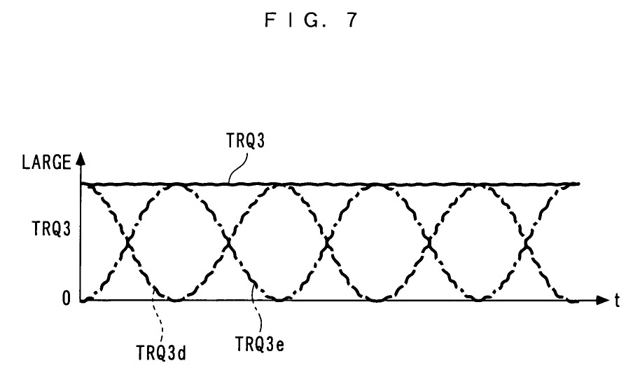

As described above, in accordance with the rotation of the inner rotor 12, a state is repeated in which the magnetic forces acting on the left soft magnetic material elements 13d, and the magnetic forces acting on the right soft magnetic material elements 13e are increased and decreased alternately, whereby the intermediate rotor 13 is driven, so that it is possible to transmit the torque TRQ2 input to the inner rotor 12 to the intermediate rotor 13. In this case, when torques transmitted via the left soft magnetic material element 13d, and the right soft magnetic material element 13e are represented by TRQ3d and TRQ3e, the relationship between torque TRQ3 transmitted to the intermediate rotor 13 and the torques TRQ3d and TRQ3e is generally as shown in FIG. 7. Referring to the figure, the two torques TRQ3d and TRQ3e repeat periodic changes, and the sum of TRQ3d and TRQ3e becomes equal to the torque TRQ3 transmitted to the intermediate rotor 13. That is, TRQ3=TRQ3d+TRQ3e holds.

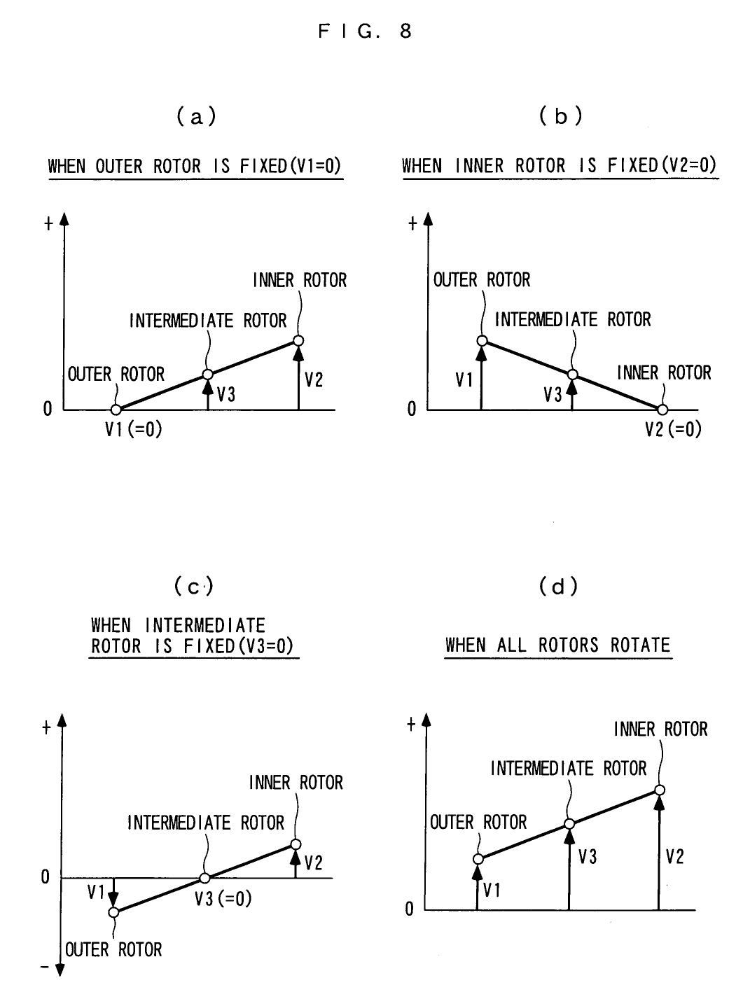

Further, as is clear from comparison between FIG. 4(a) and FIG. 5(c), when the inner rotor 12 rotates by one pitch P of the permanent magnet 11c, the intermediate rotor 13 rotates by only a half (P/2) of the same, and hence the intermediate rotor 13 is driven such that it rotates at a value equal to one half of the rotational speed of the inner rotor 12. This relationship is represented as shown in FIG. 8(a), in which V3=0.5×(V2+V1)=0.5×V2 holds. As described above, since the rotational speed V3 of the intermediate rotor 13 is reduced to one half of the rotational speed V2 of the inner rotor 12, the torque TRQ3 transmitted to the intermediate rotor 13 becomes twice as large as the torque TRQ2 of the inner rotor 12, if TRQ3 is within transmission torque capacity. That is, TRQ3=2×TRQ2 holds.

It should be noted that during the rotation of the inner rotor 12 as described above, the intermediate rotor 13, while being pulled by the inner rotor 12, is rotated by the magnetic forces generated by the first magnetic lines G1 and the second magnetic lines G2, so that the intermediate rotor 13 rotates with a small phase delay with respect to the inner rotor 12. Therefore, when the inner rotor 12 is at the position shown in FIG. 5(c) during rotation thereof, the left soft magnetic material element 13d, and the right soft magnetic material element 13e are actually positioned slightly upward of the position shown in FIG. 5(c). In FIG. 5(c), however, for ease of understanding the above-described rotational speed, the right soft magnetic material element 13e, and the left soft magnetic material element 13d are shown at the positions illustrated in the figure.

Further, inversely to the above, when the inner rotor 12 is fixed (V2=0, TRQ2=0), and the TRQ1 is input to the outer rotor 11, in accordance with the rotation of the inner rotor 12, the state is repeated in which the magnetic forces acting on the left soft magnetic material elements 13d, and the magnetic forces acting on the right soft magnetic material elements 13e are increased and decreased alternately, whereby the intermediate rotor 13 is driven, as described above. As a result, it is possible to transmit the torque TRQ1 input to the outer rotor 11 to the intermediate rotor 13.

In doing this, for the above reason, the intermediate rotor 13 is driven such that it rotates at a value equal to one half of the rotational speed of the outer rotor 11. More specifically, V3=0.5×(V1+V2)=0.5×V1 holds (see FIG. 8(b)). Further, since the rotational speed V3 of the intermediate rotor 13 is decreased by one half of the rotational speed V1 of the outer rotor 11, the torque TRQ3 transmitted to the intermediate rotor 13 becomes twice as large as the torque TRQ1 of the outer rotor 11, if TRQ3 is within the transmission torque capacity. That is, TRQ3=2×TRQ1 holds.

Next, a description will be given of a case in which the intermediate rotor 13 is fixed, and the torque TRQ2 is input to the inner rotor 12. First, it is assumed that before the start of rotation of the inner rotor 12, the three rotors 11 to 13 are in a positional relationship illustrated in FIG. 9(a). From this state, when the torque TRQ2 is input, and the inner rotor 12 rotates to a position shown in FIG. 9(b), the first magnetic line G1 between the left soft magnetic material element 13d and the permanent magnet 12c is bent, and at the same time the permanent magnet 12c becomes closer to the right soft magnetic material element 13e, whereby the length of the second magnetic line G2 between the right soft magnetic material element 13e and the magnetic pole at the right-side portion of the permanent magnet 12c is decreased to increase the total magnetic flux amount of the second magnetic line G2. As a result, the aforementioned magnetic circuits as shown in FIG. 6(b), referred to hereinabove, are formed.

In this state, although magnetic forces are generated between the left and right soft magnetic material elements 13d and 13e, and the magnetic poles at the opposite-side portions of the permanent magnets 12c, by the synergistic action of the degree of bend of the first magnetic lines G1 and the second magnetic lines G2 and the total magnetic flux amounts thereof, the magnetic forces are not influential since the inner rotor 12 is driven by the torque TRQ2, and at the same time the left and right soft magnetic material elements 13d and 13e are fixed. Further, since the first magnetic lines G1 between the magnetic poles of the left permanent magnets 11c and the left soft magnetic material elements 13d are straight although their total magnetic flux amounts are large, no magnetic forces for driving the left soft magnetic material elements 13d are generated. On the other hand, the second magnetic lines G2 between the right soft magnetic material elements 13e and the magnetic poles of the right permanent magnets 11c generate magnetic forces for pulling the right permanent magnets 11c toward the right soft magnetic material elements 13e, by the synergistic action of the degree of bend of the second magnetic lines G2 and the total magnetic flux amounts thereof, whereby the outer rotor 11 is driven in a direction (upward as viewed in FIG. 9) opposite to the direction in which the inner rotor 12 is driven, for rotation toward a position shown in FIG. 9(c).

While the outer rotor 11 rotates from the position shown in FIG. 9(b) toward the position shown in FIG. 9(c), the inner rotor 12 rotates toward a position shown in FIG. 9(d). Along with the rotation of the inner rotor 12, the permanent magnets 12c become still closer to the right soft magnetic material elements 13e, and the second magnetic lines G2 between the permanent magnets 12c and the right permanent magnets 11c increase in the total magnetic flux amounts thereof, and decrease in the degree of bend thereof, and magnetic forces that pull the right permanent magnets 11c toward the right soft magnetic material elements 13e are generated by the synergistic action of the degree of bend of the second magnetic lines G2 and the total magnetic flux amounts thereof. On the other hand, bent first magnetic lines G1 are generated between the magnetic poles of the left permanent magnets 11c and the left soft magnetic material elements 13d, and magnetic forces that pull the left permanent magnets 11c toward the left soft magnetic material elements 13d are generated by the synergistic action of the degree of bend of the first magnetic lines G1 and the total magnetic flux amounts thereof. However, the magnetic forces generated by the first magnetic lines G1 are considerably weaker than the magnetic forces generated by the second magnetic lines G2. As a result, the outer rotor 11 is driven by a magnetic force corresponding to the difference between the above magnetic forces in the direction opposite to the direction of rotation of the inner rotor 12.

When the inner rotor 12 and the outer rotor 11 are placed in a positional relationship shown in FIG. 9(d), the magnetic forces generated by the first magnetic lines G1 between the left soft magnetic material elements 13d and the magnetic pole of the left permanent magnets 11c, and the magnetic forces generated by the second magnetic lines G2 between the right soft magnetic material elements 13e and the magnetic poles of the right permanent magnets 11c are balanced, whereby the outer rotor 11 is temporarily placed in an undriven state.

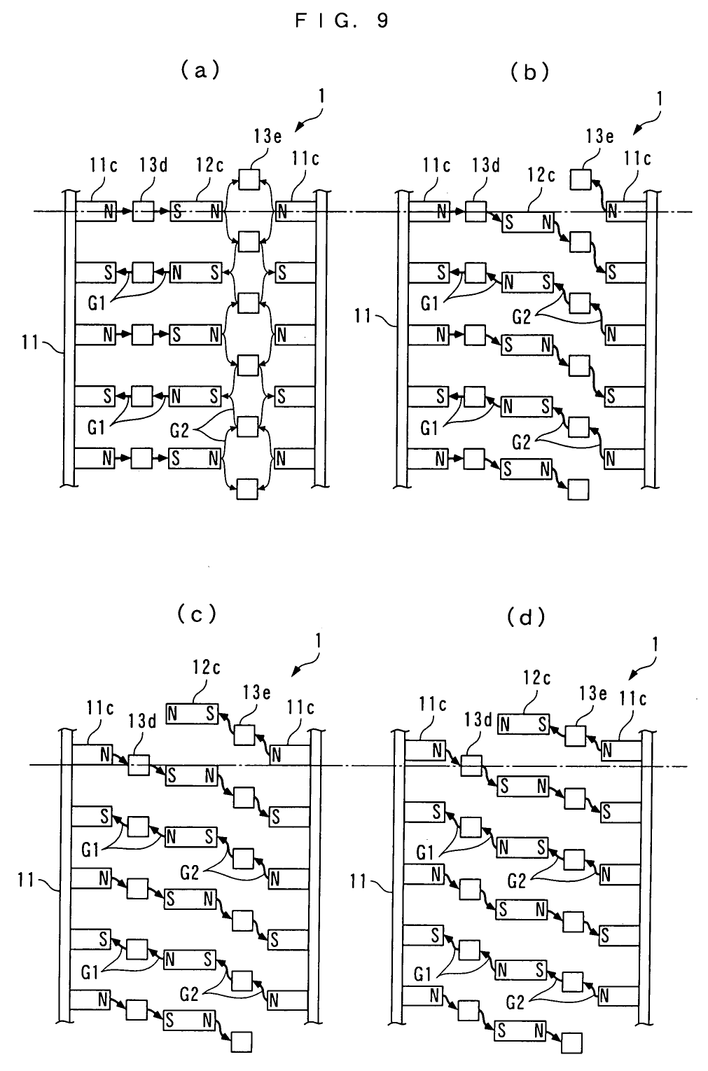

From this state, when the inner rotor 12 rotates to a position shown in FIG. 10(a), the state of generation of the first magnetic lines G1 is changed to form magnetic circuits as shown in FIG. 10(b). Thus, the magnetic forces generated by the first magnetic lines G1 cease to act to pull the left permanent magnets 11c toward the left soft magnetic material elements 13d, and therefore the right permanent magnets 11c are pulled toward the right soft magnetic material elements 13e by the magnetic forces generated by the second magnetic lines G2, whereby the outer rotor 11 is driven to a position shown in FIG. 10(c) in the direction opposite to the direction of rotation of the inner rotor 12.

When the inner rotor 12 rotates from the position shown in FIG. 10(c) slightly downward, as viewed in the figure, inversely to the above, the first magnetic lines G1 between the left soft magnetic material elements 13d and the magnetic poles of the left permanent magnets 11c generate magnetic forces that pull the left permanent magnets 11a toward the left soft magnetic material elements 13d by the synergistic action of the degree of bend of the first magnetic lines G1 and the total magnetic flux amounts thereof, whereby the outer rotor 11 is driven in the direction opposite to the direction of rotation of the inner rotor 12. When the inner rotor 12 further rotates downward, as viewed in the figure, the outer rotor 11 is driven by the magnetic force corresponding to the difference between the magnetic forces generated by the first magnetic lines G1 and the magnetic forces generated by the second magnetic lines G2, in the direction opposite to the direction of rotation of the inner rotor 12. After that, when the magnetic forces generated by the second magnetic lines G2 cease to act, the outer rotor 11 is driven only by the magnetic forces generated by the first magnetic lines G1, in the direction opposite to the direction of rotation of the inner rotor 12.

As described above, along with the rotation of the inner rotor 12, the magnetic forces generated by the first magnetic lines G1 between the left soft magnetic material elements 13d and the left permanent magnets 11c, the magnetic forces generated by the second magnetic lines G2 between the right soft magnetic material elements 13e and the right permanent magnets 11c, and the magnetic forces corresponding to the difference between the above magnetic forces alternately act on the outer rotor 11, whereby the outer rotor 11 is driven in the direction opposite to the direction of rotation of the inner rotor 12. Therefore, it is possible to transmit the torque TRQ2 input to the inner rotor 12 to the outer rotor 11. In this case, as shown in FIG. 8(c), the outer rotor 11 rotates at the same speed as that of the inner rotor 12 in the direction opposite to the direction of rotation thereof, whereby −V1=V2, i.e. |V1|=|V2| holds. As described above, the inner rotor 12 rotates at the same speed as that of the outer rotor 11 in the direction opposite to the direction of rotation thereof, so that if the torque TRQ2 input to the inner rotor 12 assumes a value within the range of the torque capacity of the magnetic power transmission system 1, the torque TRQ2 is transmitted to the outer rotor 11 without modification. That is, TRQ2=TRQ1 holds.

On the other hand, also when the intermediate rotor 13 is fixed, and the torque TRQ1 is input to the outer rotor 11, similarly to the above, the inner rotor 12 is driven such that it rotates at the same speed as that of the outer rotor 11 in the direction opposite to the direction of rotation thereof. In this case, as to the rotational speed, |V1|=|V2| holds, and as to the torque, TRQ1=TRQ2 holds.

Next, a description will be given of a case in which the three rotors 11 to 13 are all rotating. FIG. 8(a), referred to hereinabove, shows the relationship between the rotational speeds V1 to V3 of the three rotors 11 to 13, obtained when the outer rotor 11 is fixed. When the three rotors 11 to 13 are all rotating, in FIG. 8(a), it is only required to set the rotational speed V1 of the outer rotor 11 such that V1≠0 holds, and the relationship between the rotational speeds V1 to V3 is shown in FIG. 8(d). In this case, V3=0.5×(V1+V2) holds.

Since the magnetic power transmission system 1 according to the present embodiment is used as a differential unit, the three rotors 11 to 13 are all rotating during traveling of the vehicle 2, and the relationship between the rotational speeds V1 to V3 is shown in FIG. 8(d). As is clear from FIGS. 8(a) to 8(d), the rotational speeds V1 to V3 of the three rotors 11 to 13 have the same characteristics as those of the rotational speeds of three members of a planetary gear unit, so that the magnetic power transmission system 1 can be regarded as a system having the same function as that of the planetary gear unit, and performing the same operation as carried out by the same.

Further, when TRQ1≠0, TRQ2≠0, and TRQ3≠0, the torques of the three rotors 11 to 13 satisfy the relationship of TRQ1=TRQ2, and TRQ3=TRQ1+TRQ2. More specifically, the torque TRQ3 input to the intermediate rotor 13 is divided in two for being distributed to the outer rotor 11 and the inner rotor 12. It should be noted that inversely to the magnetic power transmission system 1 according to the present embodiment, also when both the outer rotor 11 and the inner rotor 12 are used as the torque input side, and the intermediate rotor 13 as the torque output side, the relationship of TRQ3=TRQ1+TRQ2 is satisfied.

As described above, according to the magnetic power transmission system 1 of the present embodiment, since torque input to any one of the three rotors 11 to 13 is transmitted to one or both of the other two rotors by magnetic forces, it is possible to execute the same torque-transmitting operation as carried out by the planetary gear unit, using the magnetic forces. Therefore, in a unit for carrying out the same torque-transmitting operation as executed by the planetary gear unit, it is possible to ensure advantageous effects peculiar to the magnetic power transmission system, that no lubricating structure is necessary, and there is no fear of generation of backlash or dusts at contact portions, for example. Further, when torque is transmitted, magnetic paths are formed using all of the left and right permanent magnets 11c and 11c, the left soft magnetic material elements 13d, the permanent magnets 12c, and the right soft magnetic material element 13e, so that it is possible to ensure the areas of the magnetic paths efficiently. As a result, compared with the conventional magnetic power transmission system which forms magnetic paths using only part of magnetic poles, it is possible to enhance the transmission efficiency of torque and transmission torque capacity, while maintaining the advantageous effects obtained by performing power transmission with magnetic forces.

Additionally, the magnetic power transmission system 1 can be realized by a relatively simple construction having the outer rotor 11 including the left and right permanent magnet rows, the inner rotor 12 having the permanent magnet row, and the intermediate rotor 13 including the left and right soft magnetic material elements, so that the manufacturing costs can be reduced compared with the conventional magnetic power transmission system provided with magnetic teeth having a complicated shape.

It should be noted that although the first embodiment is an example in which the magnetic power transmission system according to the present invention is applied to the differential unit for a vehicle, this is not limitative, but the magnetic power transmission system according to the present invention can be applied to torque-transmitting systems of various industrial apparatuses and devices, particularly to a torque-transmitting system required to perform such an operation as is carried out by the planetary gear unit. For example, the magnetic power transmission system according to the present invention may be applied to a power transmission system for a wind power generator.

Further, although the first embodiment is an example in which the left and right permanent magnets 11c and 11c, the permanent magnets 12c, the left and right soft magnetic material elements 13d and 13e are arranged in the same number at the same pitch, this is not limitative, but any suitable number and arrangement of these members may be employed insofar as the first magnetic rows and the second magnetic rows are generated such that torque transmission can be properly performed between the three rotors 11 to 13.

For example, the members may be arranged such that when each permanent magnet 12c is in a positional relationship with each of the left and right permanent magnets 11c and 11c, in which it is slightly displaced from a line connecting the centers of the left and right permanent magnets 11c and 11c, one of the left and right soft magnetic material elements 13d and 13e is in a position between the permanent magnets 11c and 12c, and the other thereof is in a position between each circumferentially adjacent two of the permanent magnets 11c and between those of the permanent magnets 12c. Further, the permanent magnets 11c and 11c, the permanent magnets 12c, and the left and right soft magnetic material elements 13d and 13e may be arranged in the same number at approximately equal intervals.

Furthermore, the left and right soft magnetic material elements 13d and 13e may be arranged in the same number at the same pitch such that the permanent magnets 11c and 11c and the permanent magnets 12c are arranged in the same number at the same pitch, and the number of the left and right soft magnetic material elements 13d and 13e is set to a value smaller than the number of the permanent magnets 11c and 11c and the permanent magnets 12c.

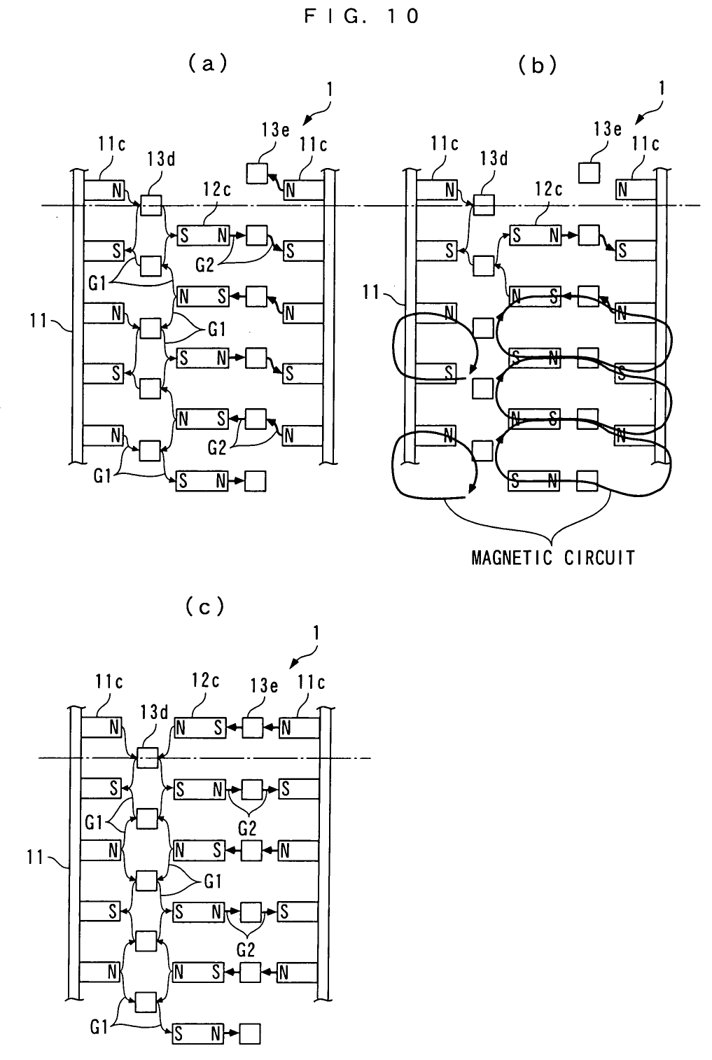

Next, a magnetic power transmission system 1B according to a second embodiment will be described with reference to FIG. 11. As shown in the figure, this magnetic power transmission system 1B according to the second embodiment corresponds to the arrangement in which the three rotors 11 to 13 of the magnetic power transmission system 1 according to the first embodiment are divided in two left and right portions, respectively, for connecting the divided portions by a gear mechanism. The other component elements are arranged similarly to the magnetic power transmission system 1 according to the first embodiment, and therefore, the following description will be given only of the different points.

The magnetic power transmission system 1B includes a pair of left and right outer rotors 21 and 21, a pair of left and right inner rotors 22 and 22, a pair of left and right intermediate rotors 23 and 23, two pairs of bearings 24 each of which is formed by left and right bearings, and three gear shafts 25 to 26 provided in a rotatable manner. The pair of left and right outer rotors 21 and 21 are arranged at respective symmetrical locations, and hence the following description is given of the left outer rotor 21, by way of example.

The left outer rotor 21 includes a rotational shaft 21a, a disk 21b concentrically and integrally formed with the rotational shaft 21a, and a gear 21d. The rotational shaft 21a is rotatably supported by a pair of bearings 24 and 24. The disk 21b is formed of a soft magnetic material element, and has a permanent magnet row formed on a right side surface thereof, at a location closer to an outer peripheral end of the surface.

The permanent magnet row is comprised of m permanent magnets 21c. As shown in FIG. 12, similarly to the aforementioned permanent magnets 11c, the permanent magnets 21c are arranged at predetermined equal intervals, and mounted to the disk 21b such that each adjacent two of the permanent magnets 21c and 21c have magnetic poles on the foremost end sides thereof having polarities different from each other. Further, the gear 21d is in constant mesh with a left gear 25a, described hereinafter, of the gear shaft 25. The left outer rotor 21 is configured as described above.

On the other hand, the right outer rotor 21 is configured such that a gear 21d thereof is in constant mesh with a right gear 25a, described hereinafter, of the gear shaft 25, and in this state, the magnetic pole of each permanent magnet 21c has the same polarity as that of the magnetic pole of an axially corresponding one of the permanent magnets 21c of the left outer rotor 21. Otherwise, the right outer rotor 21 is configured similarly to the left outer rotor 21.

Further, the gear shaft 25 includes a pair of left and right gears 25a and 25a integrally formed therewith. As described above, the left and right gears 25a and 25a are in constant mesh with the gears 21d and 21d of the left and right outer rotors 21 and 21, respectively, whereby the left and right outer rotors 21 and 21 are configured such that they rotate in the same direction at the same speed while holing the positional relationship shown in FIG. 12.

Further, the left and right inner rotors 22 and 22 are similarly configured, except for part thereof. First, a description will be given of the left inner rotor 22. The left inner rotor 22 includes a hollow cylindrical rotational shaft 22a concentrically fitted in a rotational shaft 23a of the intermediate rotor 23, described hereinafter, a disk 22b integrally formed with the rotational shaft 22a, and a gear 22d. The disk 22b is formed of a soft magnetic material element, and has a permanent magnet row formed on a left side surface thereof, at a location closer to an outer peripheral end of the surface, in a manner opposed to the permanent magnet row of the left outer rotor 21.

The permanent magnet row is comprised of m permanent magnets 22c. As shown in FIG. 12, similarly to the aforementioned permanent magnets 11c, the permanent magnets 22c are mounted to the disk 22b such that each adjacent two of the permanent magnets 22c and 22c have magnetic poles on the respective left and right ends thereof having polarities different from each other. Further, the permanent magnets 22c are arranged in the same number at the same pitch as those of the permanent magnets 21c such that they are identical to the permanent magnets 21c also in the radial distance from the center of rotation. Additionally, the opposite side surfaces of each permanent magnet 22c have approximately the same area and shape as those of the end faces of an opposed one of the permanent magnets 21c. Further, the gear 22d is in constant mesh with a left gear 26a, described hereinafter, of the gear shaft 26. The left inner rotor 22 is configured as described above.

On the other hand, the right inner rotor 22 is configured such that a gear 22d thereof is in constant mesh with a right gear 26a, described hereinafter, of the gear shaft 26, and in this state, the magnetic pole of each permanent magnet 22c has the same polarity as that of the magnetic pole of an axially corresponding one of the permanent magnets 22c of the left inner rotor 22. Otherwise, the right inner rotor 22 is configured similarly to the left inner rotor 22.

Further, the gear shaft 26 includes a pair of left and right gears 26a and 26a integrally formed therewith. As described above, the left and right gears 26a and 26a are in constant mesh with the gears 22a and 22a of the left and right inner rotors 22 and 22, respectively, whereby the left and right inner rotors 22 and 22 are configured such that they rotate in the same direction at the same speed while holing the positional relationship shown in FIG. 12.

It should be noted that in the present embodiment, either of the left and right outer rotors 21 and 21, and the left and right inner rotors 22 and 22 correspond to first and third movable members, and the other to second and fourth movable members. Further, either of the left and right permanent magnets 21c and 21c, and the left and right permanent magnets 22c and 22c correspond to the first and third magnetic poles, and the other to the second and fourth magnetic poles.

Further, the left and right intermediate rotors 23 and 23 are similarly configured, except for part thereof. First, a description will be given of the left intermediate rotor 23. The left intermediate rotor 23 includes a hollow cylindrical portion 23a concentrically and rotatably fitted in the rotational shaft 21a, a left wall 23b integrally formed with the hollow cylindrical portion 23a, and a gear 23c. A left permanent magnet row is formed at a foremost end of the left wall 23b such that it is in a position between the left permanent magnet row of the left outer rotor 21 and the permanent magnet row of the left inner rotor 22 in a manner opposed thereto.

The left soft magnetic material element row is comprised of m left soft magnetic material elements 23d. The left soft magnetic material elements 23d are arranged in the same number at the same pitch as those of the permanent magnets 21c and the permanent magnets 22c such that they are identical to the permanent magnets 21c and 22c in the radial distance from the center of rotation. Additionally, the opposite side surfaces of each left soft magnetic material element 23d have approximately the same area and shape as those of the end faces of the respective permanent magnets 21c and 22c. Further, the gear 23c is in constant mesh with a left gear 27a, described hereinafter, of the gear shaft 27.

On the other hand, the right intermediate rotor 23 has a right soft magnetic material element row comprised of m right soft magnetic material elements 23e. The right soft magnetic material elements 23e are arranged in the same number at the same pitch as those of the permanent magnets 21c and the permanent magnets 22c such that they are identical to the permanent magnets 21c and 22c in the radial distance from the center of rotation. Additionally, the opposite side surfaces of each right soft magnetic material element 23e have approximately the same area and shape as those of the end faces of the opposed ones of the permanent magnets 21c and the permanent magnets 22c.

Further, in the right intermediate rotor 23, the gear 23c thereof is in constant mesh with a right gear 27a, described hereinafter, of the gear shaft 27, and in this state, the right soft magnetic material element 23e is disposed such that it is displaced from the left soft magnetic material element 23d by a half of the pitch in the direction of rotation of the right intermediate rotor 23.

On the other hand, the distances between the respective left and right side surfaces of the left soft magnetic material element 23d, and the end face of the permanent magnet 21c of the left outer rotor 21 and the end face of the permanent magnet 22c of the left inner rotor 22, and the distances between the respective left and right side surfaces of the right soft magnetic material element 23e, and the end face of the permanent magnet 21c of the right outer rotor 21 and the end face of the permanent magnet 22c of the right inner rotor 22 are set to be equal to each other.

It should be noted that in the present embodiment, one of the left and right intermediate rotors 23 corresponds to the fifth movable member, and the other to the sixth movable member. Further, one of the left and right soft magnetic material element 23d and 23e corresponds to the first soft magnetic material element, and the other to the second soft magnetic material element.

Further, the above six rotors 21 to 23 are supported by a large number of radial bearings and thrust bearings (none of which are shown in the figures), such that they are hardly changed in the positional relationships in the directions of the rotational axis and the radial direction, and configured such that they are relatively rotatable with respect to each other about the same rotational axis.

According to the magnetic power transmission system 1B of the second embodiment configured as described above, it is possible to obtain the same advantageous effects as provided by the magnetic power transmission system 1 according to the first embodiment. More specifically, it is possible to execute the same power-transmitting operation as carried out by the planetary gear unit, using the magnetic forces. Further, the areas of the magnetic paths can be ensured, whereby compared with the conventional magnetic power transmission system which forms magnetic paths using only part of magnetic poles, it is possible to enhance the transmission efficiency of torque and transmission torque capacity, while maintaining the advantageous effects obtained by performing power transmission with magnetic forces.

It should be noted that although the magnetic power transmission system 1B according to the second embodiment is an example in which the six rotors 21 to 23 as the first to sixth movable members are connected by the gear mechanism, this is not limitative, but the magnetic power transmission system according to the present invention may be configured such that the first movable member and the third movable member, the second movable member and the fourth movable member, and the fifth movable member and the sixth movable member move relative to each other in an interlocked manner, respectively. For example, the magnetic power transmission system according to the present invention may be configured such that two movable members move relative to each other in an interlocked manner by a combination of pulleys and belts.

Further, although the magnetic power transmission system 1B according to the second embodiment is an example in which the magnetic power transmission system according to the present invention is constructed symmetrically except for the polarities of the magnetic poles of the permanent magnets 22c of the left and right inner rotor 22, and the arrangement of the left soft magnetic material elements 23d and the right soft magnetic material elements 23e of the left and right intermediate rotors 23, this is not limitative, but the magnetic power transmission system according to the present invention may be constructed unsymmetrically. For example, the left and right rotors of the outer rotors 21 and 21, the inner rotors 22 and 22, and the intermediate rotors 23 and 23 may be configured to have diameters different from each other such that the numbers and the pitches of the permanent magnets 21c, the permanent magnets 22c, and the soft magnetic material elements 23d and 23e are different between the left and right rotors.

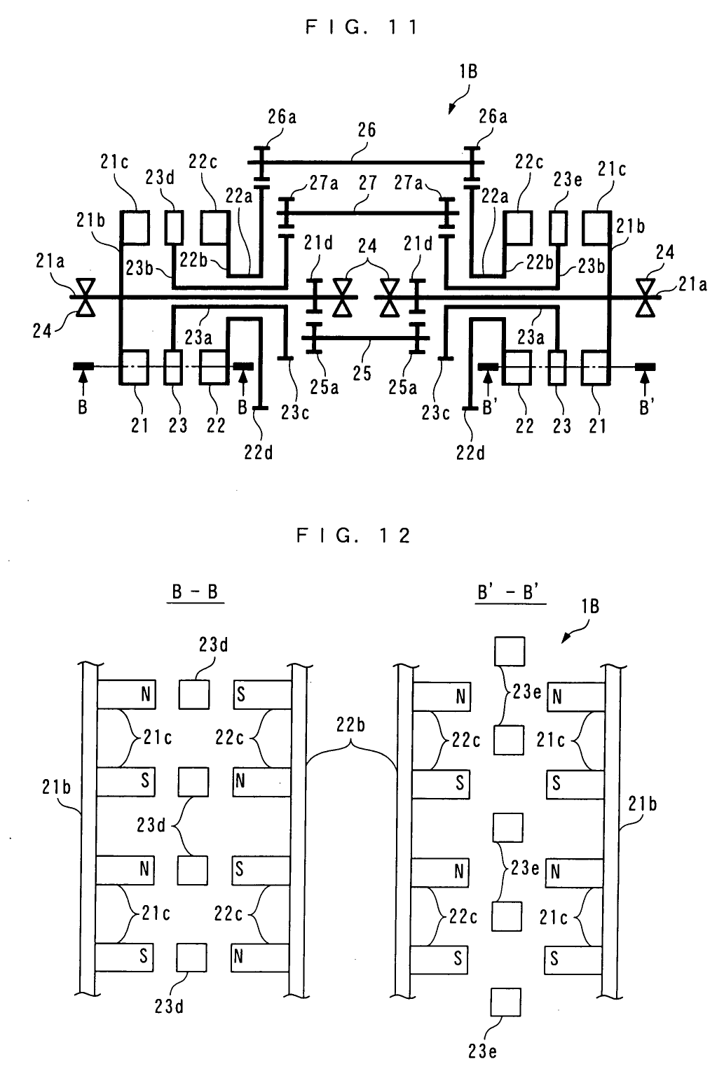

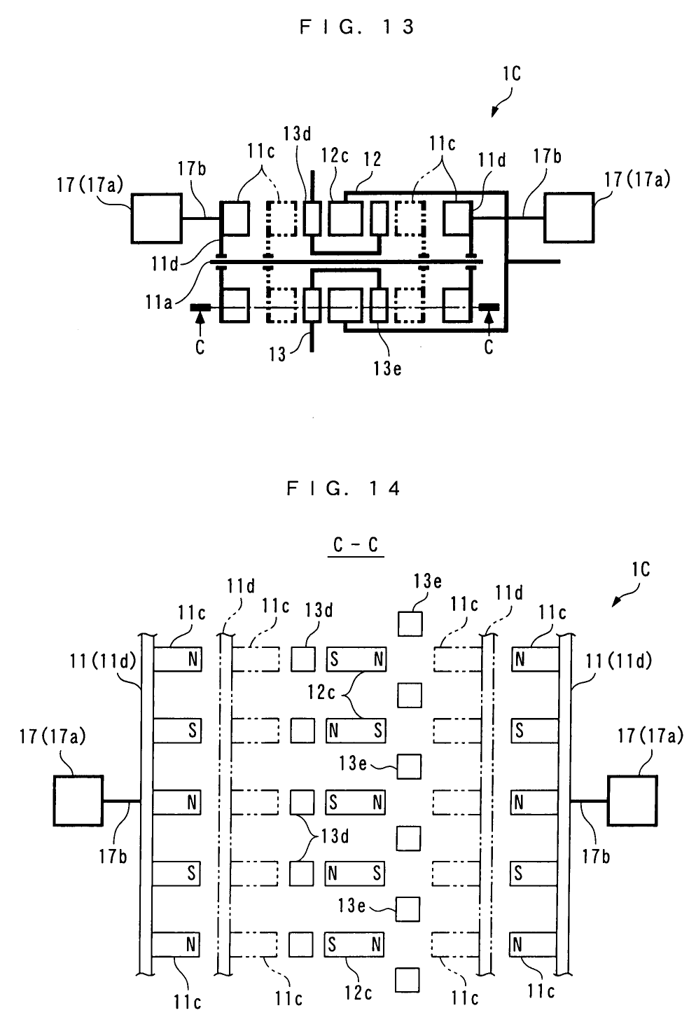

Next, a magnetic power transmission system 1C according to a third embodiment of the present invention will be described. As shown in FIG. 13 and FIG. 14, this magnetic power transmission system 1C is distinguished from the magnetic power transmission system 1 according to the first embodiment in the construction of part of the outer rotor 11, and including two actuators 17 and 17, and otherwise, it is configured similarly to the magnetic power transmission system 1. Therefore, the following description will be given mainly of the different construction, while component elements of the magnetic power transmission system 1C, identical to those of the magnetic power transmission system 1 are designated by identical reference numerals, and detailed description thereof is omitted.

As shown in the figures, the magnetic power transmission system 1C includes the outer rotor 11, and left and right actuators 17 and 17. The outer rotor 11 includes the rotational shaft 11a, and left and right disks 11d and 11d concentric with the rotational shaft 11a. The left and right disks 11d and 11d are mounted to the rotational shaft 11a by being spline-fitted therein, respectively, whereby they are configured such that they are relatively axially movable with respect to the rotational shaft 11a, for rotation in unison with the rotational shaft 11a.

Further, the left and right actuators 17 and 17 (magnetic force-changing device) have the same arrangement, and hence the following description will be given of the left actuator 17, by way of example. The left actuator 17 includes a body 17a, and a rod 17b retractable with respect to the body 17a. A foremost end of the rod 17b is connected to the left disk 11d. This actuator 17 is electrically connected to a control system, not shown, and drives the left disk 11d between a transmitting position indicated by two-dot chain lines in FIG. 13 and a blocking position indicated by solid lines in the figure, in response to a command signal from the control system.

Similarly to the left actuator 17, the right actuator 17 as well is electrically connected to the control system, not shown, and drives the right disk 11d between a transmitting position indicated by two-dot chain lines in FIG. 13 and a blocking position indicated by solid lines in the figure, in response to a command signal from the control system.

In the magnetic power transmission system 1C, when the left and right disks 11d and 11d are at the transmitting positions, similarly to the above-described magnetic power transmission system 1 according to the first embodiment, torque is transmitted between the three rotors 11 to 13. For example, when the torque TRQ3 is input to the intermediate rotor 13, the torque TRQ3 is transmitted to the outer rotor 11 and the inner rotor 12, respectively.

From the above state, when the left and right disks 11d and 11d are driven from the transmitting positions to the blocking positions by the left and right actuators 17 and 17, magnetic resistance between each permanent magnet 12c and the permanent magnets 11c and 11c of the left and right disks 11d and 11d is increased to decrease the total magnetic flux amount. In accordance with the decrease in the total magnetic flux amount, torque capacity transmitted between the three rotors 11 to 13 is reduced. Then, when the left and right disks 11d and 11d are driven to the blocking positions, respectively, the total magnetic flux amount is extremely decreased, whereby a state is generated in which no torque is transmitted between the three rotors 11 to 13.

As described above, according to the magnetic power transmission system 1C of the third embodiment, it is possible to freely drive the left and right disks 11d and 11d between the transmitting positions and the blocking positions by the actuators 17 and 17. In this case, when the left and right disks 11d and 11d are held at the transmitting positions, it is possible to obtain the same advantageous effects as provided by the magnetic power transmission system 1 according to the first embodiment. Further, by driving the left and right disks 11d and 11d from the transmitting positions toward the blocking positions, it is possible to freely change transmission torque capacity between the three rotors 11 to 13. Particularly when the left and right disks 11d and 11d are driven to the blocking positions, it is possible to block torque transmission between the three rotors 11 to 13.

It should be noted that the method of changing transmission torque capacity between the three rotors 11 to 13 and blocking transmission torque is not limited to the above-described method according to the third embodiment, but the following method can be employed. For example, a magnetic power transmission system 1D as shown in FIG. 15 may be configured in which the left disk 11d alone is driven from the transmitting position toward the blocking position by the actuator 17 (magnetic force-changing device). With this arrangement, it is possible to change transmission torque capacity between the three rotors 11 to 13.

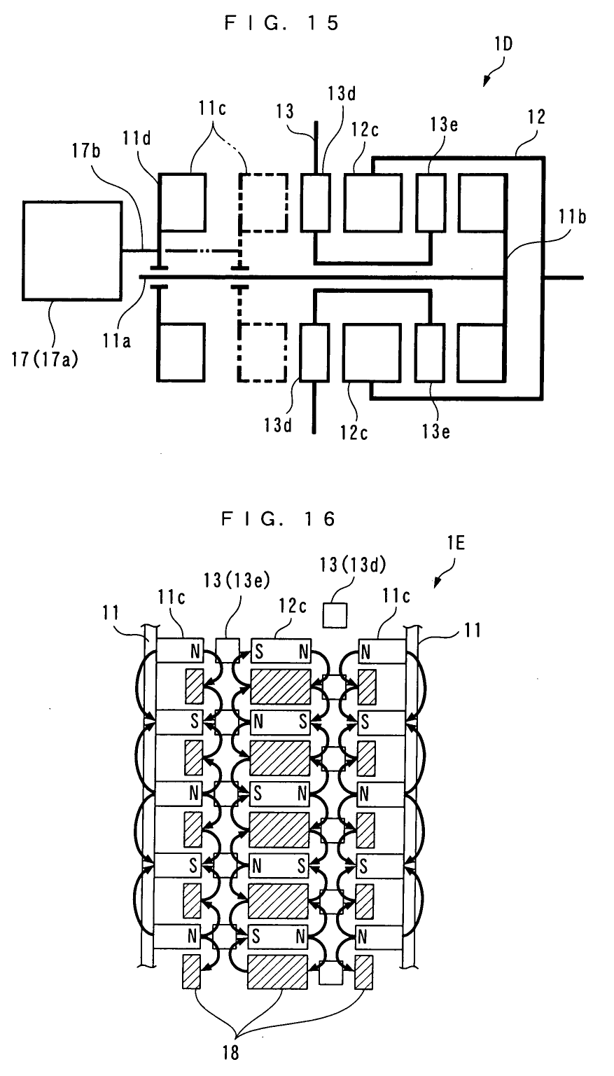

Further, a magnetic power transmission system 1E as shown in FIG. 16 may be configured in which short-circuit members 18 indicated by hatching in the figure, and an actuator, not shown, for driving the short-circuit members 18 are provided, and the short-circuit members 18 are inserted between the permanent magnets 11c and 11c and between the permanent magnets 12c and 12c by the actuator, to thereby short-circuit magnetic circuits. With this arrangement, it is possible to block torque transmission between the three rotors 11 to 13. It should be noted that in this example, the short-circuit members 18 and the actuator correspond to magnetic force-changing devices.

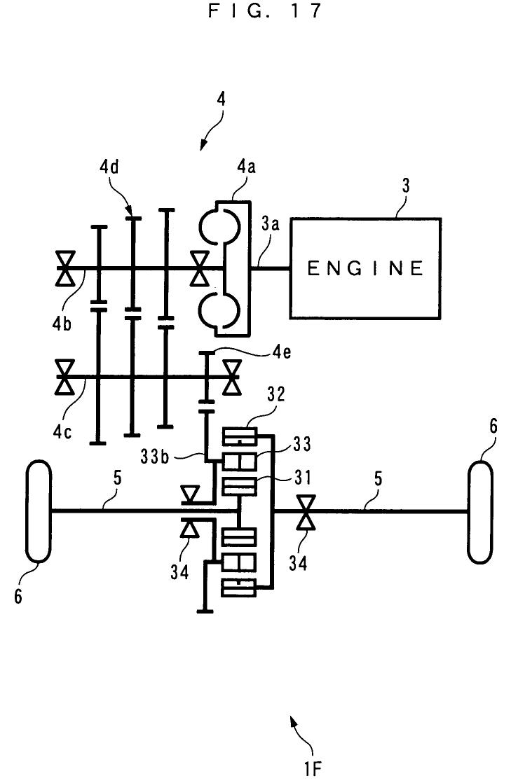

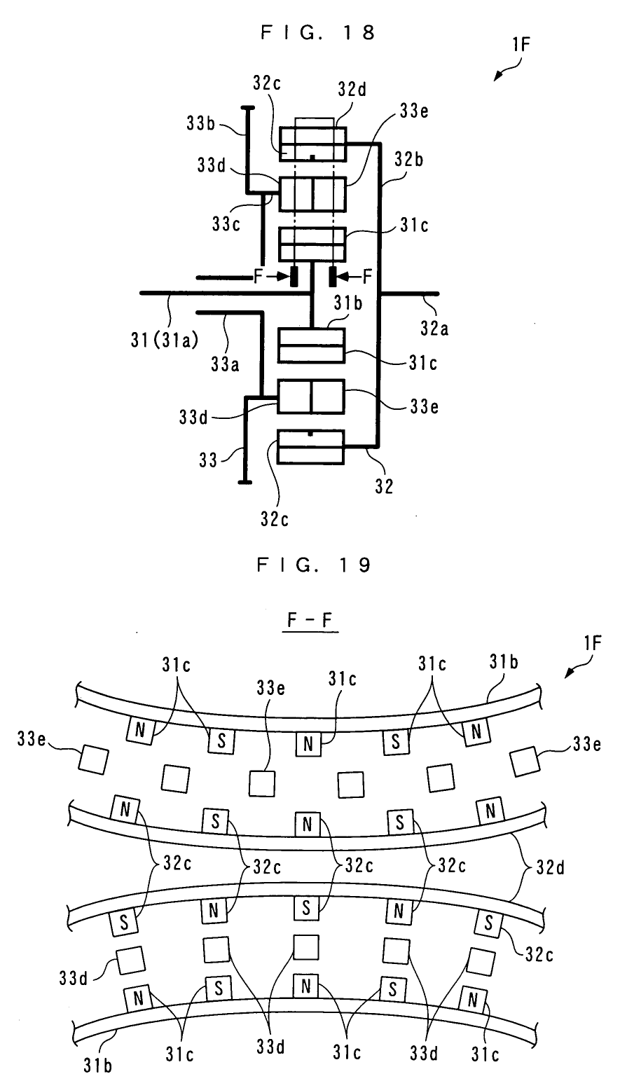

Next, a magnetic power transmission system 1F according to a fourth embodiment of the present invention will be described with reference to FIG. 17 and FIG. 18. As shown in the figures, this magnetic power transmission system 1F is applied to the differential unit of the drive system for the vehicle 2, similarly to the aforementioned magnetic power transmission system 1 according to the first embodiment. Since the vehicle 2 is configured generally similarly to the vehicle 2 to which is applied the first embodiment, the following description will be given only of a construction different from that of the first embodiment, and detailed description thereof is omitted.

The magnetic power transmission system 1F includes a small-diameter rotor 31, a large-diameter rotor 32, and an intermediate-diameter rotor 33, and the three rotors 31 to 33 are supported by a large number of radial bearings and thrust bearings (none of which are shown in the figures), such that they are hardly changed in the mutual positional relationships in the direction of the rotational axis and the radial direction, and configured such that they are relatively rotatable with respect to each other about the same rotational axis.

The small-diameter rotor 31 includes a rotational shaft 31a connected to the drive shaft 5, and a turntable 31b integrally formed with a right end of the rotational shaft 31a. The turntable 31b is made of a soft magnetic material element, and has a laid-down H shape in cross-section. A permanent magnet row is axially formed on an outer peripheral surface thereof. The permanent magnet row is comprised of m permanent magnets 31c, which are arranged, as described hereinafter.

Further, the large-diameter rotor 32 includes a rotational shaft 32a concentric with the rotational shaft 31a of the small-diameter rotor 31 and connected to the drive shaft 5, and a hollow cylindrical casing portion 32b concentrically and integrally formed with the rotational shaft 32a. A ring 32d made of a soft magnetic material element is fixed to a foremost end of the casing portion 32b. A permanent magnet row is formed on the ring 32d in a manner opposed to the permanent magnet row of the large-diameter rotor 32. The permanent magnet row is comprised of m permanent magnets 32c, which are arranged, as described hereinafter.

It should be noted that in the present embodiment, one of the small-diameter rotor 31 and the large-diameter rotor 32 corresponds to the first, third, and seventh movable members, and the other to the second, fourth and eighth movable members. Further, one of the left and right permanent magnets 31c and 32c corresponds to the first and third magnetic poles, and the other to the second and fourth magnetic poles.

On the other hand, the intermediate-diameter rotor 33 includes a hollow cylindrical portion 33a rotatably fitted in the rotational shaft 31a, a gear 33b integrally formed with the hollow cylindrical portion 33a, in constant mesh with the output gear 4e of the automatic transmission 4, an annular protruding portion 33c protruding from a right side surface of the gear 33b, and left and right soft magnetic material element rows formed on the protruding portion 33c. The left and right soft magnetic material element rows are comprised of m left and right soft magnetic material elements 33d and 33e, respectively, and the left and right soft magnetic material elements 33d and 33e are arranged, described hereinafter.

It should be noted that in the present embodiment, the intermediate-diameter rotor 33 corresponds to the fifth, sixth and ninth movable members, while one of the left and right soft magnetic material elements 33d and 33e corresponds to the first soft magnetic material element, and the other to the second soft magnetic material element.

FIG. 19 is a schematic development view of part of a cross-section of the magnetic power transmission system taken on line F-F of FIG. 18 along the circumferential direction. In FIG. 19, hatching indicative of cross-sectional portions is omitted for ease of understanding. As shown in the figure, each adjacent two of the permanent magnets 31c, the permanent magnets 32c, the left soft magnetic material elements 33d, and the right soft magnetic material elements 33e are arranged at the same predetermined angle, and the permanent magnets 31c and the permanent magnets 32c are provided such that they are on the same straight line radially extending from the center of rotation.

Further, the left and right soft magnetic material elements 33d and 33e are arranged such that they are circumferentially displaced from each other by a half of the pitch. Furthermore, the permanent magnets 31c are arranged such that the magnetic poles of each adjacent two thereof have polarities different from each other, and the permanent magnets 32c as well are arranged such that the magnetic poles of each adjacent two thereof have polarities different from each other. Additionally, the permanent magnets 31c, the permanent magnets 32c, the left soft magnetic material elements 33d, and the right soft magnetic material elements 33e are formed such that surfaces thereof opposed to each other have approximately the same area and shape.

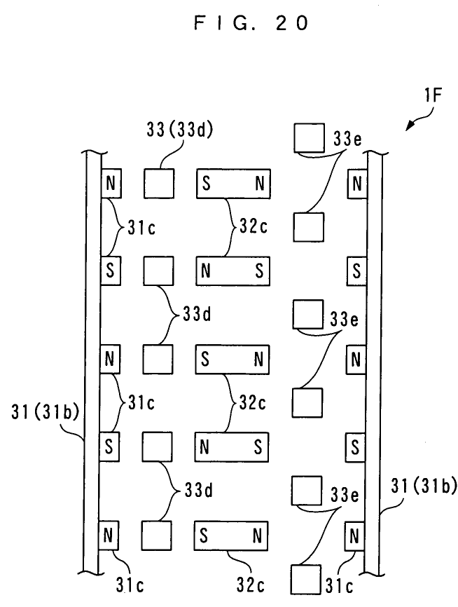

Here, since two of the permanent magnets 32c and 32c, and the two rings 32d and 32d, shown in FIG. 19, are actually one member, the arrangement shown in the figure can be regarded as one corresponding to the arrangement shown in FIG. 20. As is clear from comparison between FIG. 20 and FIG. 3, referred to hereinabove, the permanent magnets 31c, the left soft magnetic material elements 33d, the permanent magnets 32c, the right soft magnetic material elements 33e, and the permanent magnets 31c are arranged in a relative positional relationship equivalent to the relative positional relationship between the left permanent magnets 11c, the left soft magnetic material elements 13d, the permanent magnets 12c, the right soft magnetic material elements 13e, and the right permanent magnets 11c.

Therefore, in the magnetic power transmission system 1F, the small-diameter rotor 31 corresponds to the aforementioned outer rotor 11, the large-diameter rotor 32 to the inner rotor 12, and the intermediate-diameter rotor 33 to the intermediate rotor 13, whereby the same torque-transmitting operation as executed by the three rotors 11 to 13 according to the first embodiment can be executed by the three rotors 31 to 33.

As described above, according to the magnetic power transmission system 1F of the fourth embodiment, it is possible to obtain the same advantageous effects as provided by the magnetic power transmission system 1 according to the first embodiment. More specifically, it is possible to execute the same power-transmitting operation as carried out by the planetary gear unit, using the magnetic forces. Further, compared with the conventional magnetic power transmission system which forms magnetic paths using only part of magnetic poles, it is possible to enhance the transmission efficiency of torque and transmission torque capacity, while maintaining the advantageous effects obtained by performing power transmission with magnetic forces. Additionally, the three rotors 31 to 33 are radially arranged side by side, whereby the axial sizes of the three rotors 31 to 33 can be made more compact than those of the three rotors 11 to 13 in the magnetic power transmission system 1 in which the three rotors 11 to 13 are arranged side by side in the axial direction.

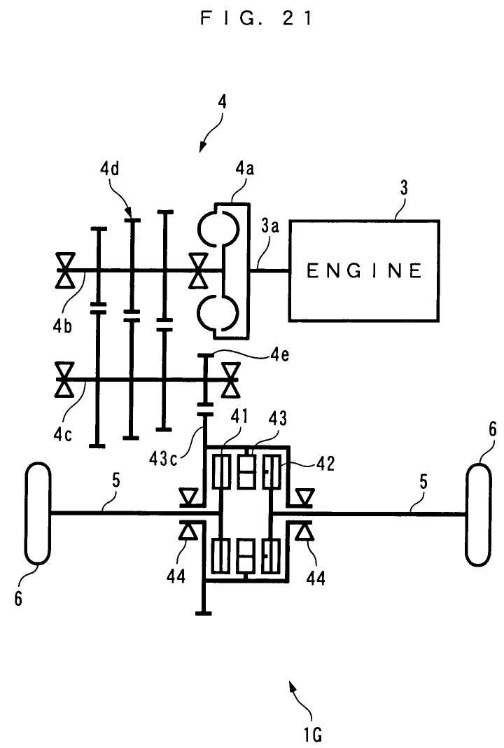

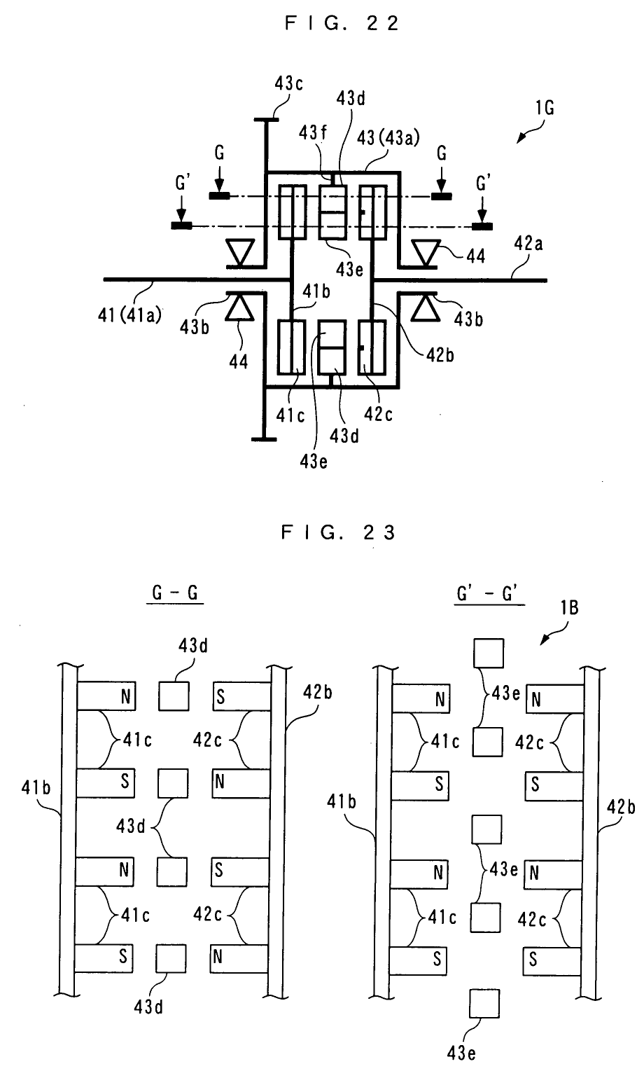

Next, a magnetic power transmission system 1G according to a fifth embodiment of the present invention will be described with reference to FIG. 21 and FIG. 22. This magnetic power transmission system 1G is applied to the differential unit of the drive system for the vehicle 2, similarly to the magnetic power transmission system 1 according to the first embodiment. The magnetic power transmission system 1G includes a left rotor 41, a right rotor 42, and an intermediate rotor 43, and the three rotors 41 to 43 are supported by a large number of radial bearings and thrust bearings (none of which are shown in the figures), such that they are hardly changed in the mutual positional relationships in the direction of the rotational axis and the radial direction, and configured such that they are relatively rotatable with respect to each other about the same rotational axis.

The left rotor 41 includes a rotational shaft 41a connected to the drive shaft 5, and a turntable 41b integrally formed with a right end of the rotational shaft 41a. The turntable 41b is made of a soft magnetic material element, and has a permanent magnet row axially formed at a portion closer to an outer periphery of a right side surface thereof. The permanent magnet row is comprised of m permanent magnets 41c, which are arranged, as described hereinafter.

The right rotor 42 includes a rotational shaft 42a concentric with the rotational shaft 41a of the left rotor 41 and connected to the drive shaft 5, and a turntable 42b integrally formed with a left end of the rotational shaft 42a. The turntable 42b is made of a soft magnetic material element, and has a permanent magnet row axially formed at a portion closer to an outer periphery of a right side surface thereof. The permanent magnet row is comprised of m permanent magnets 42c, which are arranged, as described hereinafter.

It should be noted that in the present embodiment, one of the left and right rotors 41 and 42 corresponds to the first, third and seventh movable members, and the other to the second, fourth, and eighth movable members. Further, one of the permanent magnet 41c and the permanent magnet 42c corresponds to the first and third magnetic poles, and the other to the second and fourth magnetic poles.

On the other hand, the intermediate rotor 43 includes a hollow cylindrical casing portion 43a, hollow shafts 43b and 43b integrally formed with the left and right sides of the casing portion 43a, for being rotatably fitted in the rotational shafts 41a and 42a, a gear 43c integrally formed with the casing portion 43a, in constant mesh with the output gear 4e of the automatic transmission 4, an annular protruding portion 43f protruding from an inner wall surface of the casing portion 43a, and outer and inner soft magnetic material element rows formed on the protruding portion 43f. The outer and inner soft magnetic material element rows are comprised of m outer and inner soft magnetic material elements 43d and 43e, respectively, and the outer and inner soft magnetic material elements 43d and 43e are arranged, described hereinafter.

It should be noted that in the present embodiment, the intermediate rotor 43 corresponds to the fifth, sixth and ninth movable members, while one of the outer and inner soft magnetic material elements 43d and 43e corresponds to the first soft magnetic material element, and the other to the second soft magnetic material element.

FIG. 23 is a planar development view of part of a cross-section of the FIG. 21 magnetic power transmission system taken on lines G-G, and G′-G7 of FIG. 22 along the circumferential direction. In the figure, hatching of the part of the cross-section is omitted for ease of understanding. As shown in the figure, each adjacent two of the permanent magnets 41c, the permanent magnets 42c, the outer soft magnetic material elements 43d, and the inner soft magnetic material elements 43e are circumferentially arranged at the same pitch, and the permanent magnets 41c and the permanent magnets 42c are provided at a position where they are opposed to each other.

Further, the outer soft magnetic material elements 43d and the inner soft magnetic material elements 43e are arranged such that they are circumferentially displaced from each other by a half of the pitch. Furthermore, the permanent magnets 42c are arranged such that the magnetic poles of each adjacent two thereof have polarities different from each other. Additionally, the permanent magnets 41c, the permanent magnets 42c, the outer soft magnetic material elements 43d, and the inner soft magnetic material elements 43e are formed such that surfaces thereof opposed to each other have approximately the same area and shape.

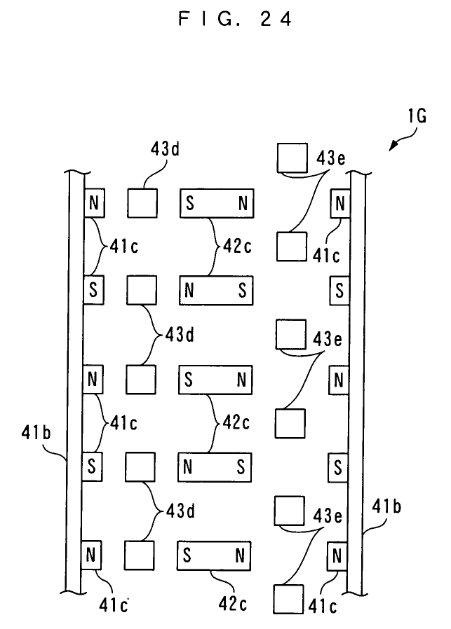

On the other hand, since two of the permanent magnets 41c and 41c, and the two turntables 42b and 42b, shown in FIG. 23, are actually one member, the arrangement shown in FIG. 23 can be regarded as one corresponding to the arrangement shown in FIG. 24. As is clear from comparison between FIG. 24 and FIG. 3, referred to hereinabove, the permanent magnets 41c, the outer soft magnetic material elements 43d, the permanent magnets 42c, the inner soft magnetic material elements 43e, and the permanent magnets 41c are arranged in a relative positional relationship equivalent to the relative positional relationship between the left permanent magnets 11c, the left soft magnetic material elements 13d, the permanent magnets 12c, the right soft magnetic material elements 13e, and the right permanent magnets 11c.

Therefore, in the magnetic power transmission system 1G, the left rotor 41 corresponds to the aforementioned outer rotor 11, the right rotor 42 to the inner rotor 12, and the intermediate rotor 43 to the intermediate rotor 13, whereby the same torque-transmitting operation as executed by the three rotors 11 to 13 according to the first embodiment can be executed by the three rotors 41 to 43.

As described above, according to the magnetic power transmission system 1G of the fifth embodiment, it is possible to obtain the same advantageous effects as provided by the magnetic power transmission system 1 according to the first embodiment. Additionally, the axial sizes of the three rotors 41 to 43 can be made more compact than those of the three rotors 11 to 13 in the first embodiment, whereby the axial size of the whole system can be made compact.

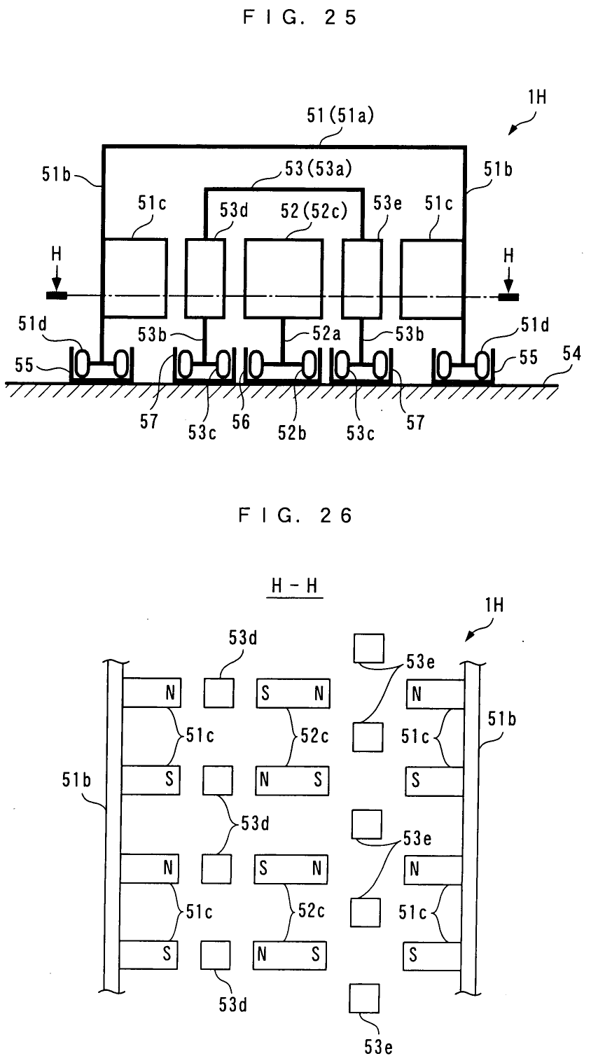

Next, a magnetic power transmission system 1H according to a sixth embodiment of the present invention will be described with reference to FIG. 25 and FIG. 26. FIG. 26 shows a cross-section of the magnetic power transmission system taken on line H-H of FIG. 25. In the figure, hatching of cross-section portions is omitted for ease of understanding. This magnetic power transmission system 1H is provided for transmitting a driving force acting frontward or rearward, as viewed in FIG. 25 (hereinafter referred to as “the front-rear direction”) in the same direction or the opposite direction, and includes an outer slider 51, an inner slider 52, and an intermediate slider 53.

The outer slider 51 is made of a soft magnetic material element, and includes a flat top wall 51a extending in the front-rear direction, and left and right side walls 51b and 51b extending downward from opposite ends of the top wall 51a. Left and right permanent magnet rows are formed on inner surfaces of the side walls 51b and 51b in a manner extending in the front-rear direction. The respective left and right permanent magnet rows are comprised of a predetermined number of symmetrically arranged left and right permanent magnets 51c. As shown in FIG. 26, these permanent magnets 51c are arranged at predetermined intervals in the front-rear direction such that the magnetic poles on the opposite sides of each adjacent two permanent magnets 51c and 51c have polarities different from each other.

Further, a plurality of rollers 51d (only one of which is shown) are amounted to a lower end of each side wall 51b. The rollers 51d are accommodated within a guide rail 55 which is placed on a floor 54, for extending in the front-rear direction. With the above arrangement, when the driving force acts on the outer slider 51 in the front-rear direction, the plurality of rollers 51d roll while being guided by the guide rail 55, whereby the outer slider 51 moves in the front-rear direction.

Further, the inner slider 52 includes a body 52a extending in the front-rear direction along the side walls 51b and 51b of the outer slider, a plurality of rollers 52b (only one of which is shown) amounted to a lower end of the body 52a, and a permanent magnet row formed on an upper end of the body 52a. The permanent magnet row is comprised of a predetermined number of permanent magnets 52c. The permanent magnets 52c are arranged at the same intervals as the intervals at which the permanent magnets 51c are arranged, in the front-rear direction, such that the magnetic poles of each adjacent two of the permanent magnets 52c have polarities different from each other.

On the other hand, the rollers 52b are accommodated within a guide rail 56 which is placed on the floor 54, for extending in the front-rear direction. With the above arrangement, when the driving force acts on the inner slider 52 in the front-rear direction, the plurality of rollers 52b roll while being guided by the guide rail 56, whereby the inner slider 52 moves in the front-rear direction.

It should be noted that in the present embodiment, one of the outer and inner sliders 51 and 52 corresponds to the first, third and seventh movable members, and the other to the second, fifth, and eighth movable members. Further, either of the left and right permanent magnets 51c and the permanent magnets 52c correspond to the first and third magnetic poles, and the other to the second and fifth magnetic poles.

On the other hand, the intermediate slider 53 includes a flat top wall 53a extending in the front-rear direction, and left and right side walls 53b and 53b extending downward from opposite ends of the top wall 53a. A plurality of rollers 53c (only one of which is shown) are amounted to a lower end of each side wall 53b. The rollers 53c are accommodated within a guide rail 57 which is placed on the floor 54, for extending in the front-rear direction. With the above arrangement, when the driving force acts on the intermediate slider 53 in the front-rear direction, the plurality of rollers 53c roll while being guided by the guide rail 57, whereby the intermediate slider 53 moves in the front-rear direction.

Further, a left soft magnetic material element row is formed at the center of the left side wall in a manner extending in the front-rear direction. The left soft magnetic material element row is comprised of a predetermined number of left soft magnetic material elements 53d. As shown in FIG. 26, the left soft magnetic material elements 53d are arranged at the same intervals as the intervals at which the permanent magnets 51c and 52c are arranged, in the front-rear direction. Furthermore, a right soft magnetic material element row is formed at the center of the right side wall in a manner extending in the front-rear direction. The right soft magnetic material element row is comprised of a predetermined number of right soft magnetic material elements 53e. The right soft magnetic material elements 53e are arranged at the same intervals as the intervals at which the permanent magnets 51c and 52c are arranged, in a state in which they are displaced from the left soft magnetic material elements 53d by a half of the pitch in the front-rear direction.

It should be noted that in the present embodiment, the intermediate slider 53 corresponds to the fifth, sixth and ninth movable members, while one of the left and right soft magnetic material elements 53d and 53e corresponds to the first soft magnetic material element, and the other to the second soft magnetic material element.

Further, in the magnetic power transmission system 1H, when the driving force is transmitted to any one of the outer slider 51, the inner slider 52, and the intermediate slider 53, the number of either of the left and right permanent magnets 51c and 51c, the left and right soft magnetic material elements 53d and 53e, or the permanent magnets 52c, of the slider to which the driving force is transmitted, is set to a value smaller than the numbers of the others.

The magnetic power transmission system 1H according to the sixth embodiment is configured as described above. As is clear from comparison between FIG. 26 and FIG. 3, referred to hereinabove, the permanent magnets 51c, the left soft magnetic material elements 53d, the permanent magnets 52c, the right soft magnetic material elements 53e, and the permanent magnets 51c are arranged in a relative positional relationship equivalent to the above-described relative positional relationship between the permanent magnets 11c, the left soft magnetic material elements 13d, the permanent magnets 12c, the right soft magnetic material elements 13e, and the permanent magnets 11c.

Therefore, in the magnetic power transmission system 1H, the driving force acting in the front-rear direction can be transmitted between the three sliders 51 to 53 by magnetic lines generated between the permanent magnet 51c, the left soft magnetic material element 53d, the permanent magnet 52c, the right soft magnetic material element 53e, and the permanent magnet 51c. For example, when the outer slider 51 is fixed, and the driving force is input to the inner slider 52, it is possible to drive the intermediate slider 53 in the same direction at a half of the speed of the inner slider 52, and transmit a driving force twice as large as a value input to the inner slider 52 to the intermediate slider 53.

As described hereinabove, according to the magnetic power transmission system 1H, it is possible to transmit a driving force input to any one of the three sliders 51 to 53, as a driving force linearly acting on both or one of the other two sliders, by magnetic forces. In doing this, magnetic circuits are formed by using all of any of the left and right permanent magnets 51c and 51c, the left and right soft magnetic material elements 53d and 53e, or the permanent magnets 52c, of a slider to which the driving force is input, and hence it is possible to efficiently ensure the areas of magnetic paths. As a result, compared with the conventional magnetic power transmission system which forms magnetic paths using only part of magnetic poles, it is possible to enhance power transmission efficiency and power transmission capacity, while maintaining the advantageous effects obtained by performing power transmission with magnetic forces.

Additionally, the magnetic power transmission system 1H can be realized using a relatively simple arrangement of the intermediate slider 53 which is provided with the outer slider 51 including left and right permanent magnet rows, the inner slider 52 including a permanent magnet row, and the intermediate slider 53 including left and right soft magnetic material element rows.

It should be noted that although the magnetic power transmission systems according to the above-described embodiments are all examples in which use permanent magnets as magnetic poles, this is not limitative, but the magnetic power transmission system according to the present invention may be configured to employ electromagnets as magnetic poles.

### BRIEF DESCRIPTION OF THE DRAWINGS

[FIG. 1] A skeleton diagram schematically showing a vehicle drive system to which is applied a magnetic power transmission system according to a first embodiment of the present invention.

[FIG. 2] A skeleton diagram schematically showing essential components of the magnetic power transmission system.

[FIG. 3] A development view of part of a cross-section of the FIG. 1 magnetic power transmission system taken on line A-A of FIG. 2 along in a circumferential direction.

[FIG. 4] A diagram which is useful in explaining operations carried out by the magnetic power transmission system when an outer rotor is fixed to input torque to an inner rotor.

[FIG. 5] A diagram which is useful in explaining operations continued from the FIG. 4 operation.

[FIG. 6] A diagram showing magnetic circuits formed during the operation of the magnetic power transmission system.

[FIG. 7] A diagram showing torque transmitted to an intermediate rotor during the operation of the magnetic power transmission system.

[FIG. 8] Velocity diagrams each representative of the rotational speed of three rotors, in respective cases of (a) in which the outer rotor is fixed, and torque is input to the inner rotor; (b) in which the inner rotor is fixed, and torque is input to the outer rotor; (c) in which the intermediate rotor is fixed, torque is input to the inner rotor; and (d) in which all the rotors are rotating.

[FIG. 9] A diagram which is useful in explaining operations carried out by the magnetic power transmission system when the intermediate rotor is fixed to input torque to the inner rotor.

[FIG. 10] A diagram which is useful in explaining operations continued from the FIG. 9 operation.

[FIG. 11] A skeleton diagram schematically showing a magnetic power transmission system according to a second embodiment.

[FIG. 12] A development view of part of a cross-section of the FIG. 11 magnetic power transmission system taken on lines B-B and B′-B′ of FIG. 11 along the circumferential direction.

[FIG. 13] A skeleton diagram schematically showing a magnetic power transmission system according to a third embodiment.

[FIG. 14] A development view of part of a cross-section of the FIG. 13 magnetic power transmission system taken on line C-C of FIG. 13 along the circumferential direction.

[FIG. 15] A skeleton diagram schematically showing a variation of the magnetic power transmission system.

[FIG. 16] A diagram schematically showing another variation of the magnetic power transmission system.

[FIG. 17] A skeleton diagram schematically showing a vehicle drive system to which is applied a magnetic power transmission system according to a fourth embodiment.

[FIG. 18] A skeleton diagram schematically showing essential components of the magnetic power transmission system according to the fourth embodiment.

[FIG. 19] A schematic development view of part of a cross-section of the FIG. 17 magnetic power transmission system taken on line F-F of FIG. 18 along the circumferential direction.

[FIG. 20] A diagram showing functionally the same arrangement as that of FIG. 19 development view.

[FIG. 21] A skeleton diagram schematically showing a vehicle drive system to which is applied a magnetic power transmission system according to a fifth embodiment.

[FIG. 22] A skeleton diagram schematically showing essential components of the magnetic power transmission system according to the fifth embodiment.

[FIG. 23] A development view of part of a cross-section of the FIG. 21 magnetic power transmission system taken on lines G-G and G′-G′ of FIG. 21 along the circumferential direction.

[FIG. 24] A diagram showing functionally the same arrangement as that of FIG. 23 development view.

[FIG. 25] A skeleton diagram schematically showing a magnetic power transmission system according to a sixth embodiment.

[FIG. 26] A cross-sectional view of part of a cross-section of the FIG. 25 magnetic power transmission system taken on line H-H of FIG. 23.

### DESCRIPTION OF REFERENCE NUMERALS

1 magnetic power transmission system
1B to 1C magnetic power transmission system
11 outer rotor (first, third, and seventh movable members, or second, fourth, eighth movable members)
11c left and right permanent magnets (first and third magnetic poles, or second and fourth magnetic poles)
12 inner rotor (second, fourth, and eighth movable members, or first, third, and seventh movable members)
12c permanent magnets (second and fourth magnetic poles, or first and third magnetic poles)
13 intermediate rotor (fifth, sixth, and ninth movable members)
13d left soft magnetic material element (first or second soft magnetic material element)
13e right soft magnetic material element (second or first soft magnetic material element)
17 actuator (magnetic force-changing device)
18 short-circuit member (magnetic force-changing device)
21 left and right outer rotor (first and third movable members, or second and fourth movable members)
21c left and right permanent magnets (first and third magnetic poles, or second and fourth magnetic poles)
22 left and right inner rotor (second and fourth movable members, or first and third movable members)
22c left and right permanent magnets (second and fourth magnetic poles, or first and third magnetic poles)
23 left and right intermediate rotor (fifth and sixth movable members)
23d left soft magnetic material element (first or second soft magnetic material element)
23e right soft magnetic material element (second or first soft magnetic material element)
31 small-diameter rotor (first, third, and seventh movable members, or second, fourth, and eighth movable members)
31c left and right permanent magnets (first and third magnetic poles, or second and fourth magnetic poles)
32 large-diameter rotor (second, fourth, and eighth movable members, or first, third, and seventh movable members)
32c permanent magnets (second and fourth magnetic poles, or first and third magnetic poles)
33 intermediate-rotor (fifth, sixth, and ninth movable members)
33d left soft magnetic material element (first or second soft magnetic material element)
33e right soft magnetic material element (second or first soft magnetic material element)
41 left rotor (first, third, and seventh movable members, or second, fourth, and eighth movable members)
41c permanent magnets (first and third magnetic poles, or second and fourth magnetic poles)
42 right rotor (second, fourth, and eighth movable members, or first, third, and seventh movable members)
42c permanent magnets (second and fourth magnetic poles, or first and third magnetic poles)
43 intermediate rotor (fifth, sixth, and ninth movable members)
43d outer soft magnetic material element (first or second soft magnetic material element)
43e inner soft magnetic material element (second or first soft magnetic material element)
51 outer slider (first, third, and seventh movable members, or second, fourth, and eighth movable members)
51c left and right permanent magnets (first and third magnetic poles, or second and fourth magnetic poles)
52 inner slider (second, fourth, and eighth movable members, or first, third, and seventh movable members)
52c permanent magnets (second and fourth magnetic poles, or first and third magnetic poles)
53 intermediate slider (fifth, sixth, and ninth movable members)
53d left soft magnetic material element (first or second soft magnetic material element)
53e right soft magnetic material element (second or first soft magnetic material element)

1. A magnetic power transmission system, comprising:
a first movable member comprising a first magnetic pole row, said first magnetic pole row comprising a plurality of first magnetic poles at approximately equal intervals in a predetermined direction;
a second movable member comprising a second magnetic pole row, said second magnetic pole row comprising a plurality of second magnetic poles at approximately equal intervals in said predetermined direction;
a third movable member comprising a third magnetic pole row, said third magnetic pole row comprising a plurality of third magnetic poles at approximately equal intervals in said predetermined direction;
a fourth movable member comprising a fourth magnetic pole row, said fourth magnetic pole row comprising a plurality of fourth magnetic poles at approximately equal intervals in said predetermined direction;
a fifth movable member comprising a first soft magnetic material element row, said first soft magnetic material element row comprising a plurality of first soft magnetic material elements at approximately equal intervals in said predetermined direction;
and a sixth movable member comprising a second soft magnetic material element row, said second soft magnetic material element row comprising a plurality of second soft magnetic material elements at approximately equal intervals in said predetermined direction,
wherein when each said first magnetic pole and each said second magnetic pole are in a first opposed position opposed to each other, each said third magnetic pole and each said fourth magnetic pole are in a second opposed position opposed to each other; when each said first magnetic pole and each said second magnetic pole in said first opposed position comprise polarities different from each other, each said third magnetic pole and each said fourth magnetic pole in said second opposed position comprise polarities identical to each other; and when each said first magnetic pole and each said second magnetic pole in said first opposed position comprise polarities identical to each other, each said third magnetic pole and each said fourth magnetic pole in said second opposed position comprise polarities different from each other.

2. The magnetic power transmission system of claim 1, wherein when each said first magnetic pole and each said second magnetic pole are in said first opposed position, if each said first soft magnetic material element is between said first magnetic pole and said second magnetic pole, each said second soft magnetic material element is between two pairs of third magnetic poles and fourth magnetic poles adjacent to each other in said predetermined direction, and if each said second soft magnetic material element is between said third magnetic pole and said fourth magnetic pole, each said first soft magnetic material element is between two pairs of first magnetic poles and second magnetic poles which are adjacent to each other in said predetermined direction.

3. The magnetic power transmission system of claim 2, wherein each two adjacent first magnetic poles comprise polarities different from each other; and wherein said first movable member is configured to move along said predetermined direction.

4. The magnetic power transmission system of claim 3, wherein each two adjacent second magnetic poles comprise polarities different from each other; and wherein said second movable member being relatively movable with respect to said first movable member along said predetermined direction.

5. The magnetic power transmission system of claim 4, wherein each two adjacent third magnetic poles comprise polarities different from each other; and wherein said third movable member is configured to move relative to said first movable member in an interlocked manner to move along said predetermined direction.

6. The magnetic power transmission system of claim 5, wherein each two adjacent fourth magnetic poles comprise polarities different from each other; wherein said fourth magnetic pole row is opposed to said third magnetic pole row; and wherein said fourth movable member is configured to move relative to said second movable member in an interlocked manner along said predetermined direction.

7. The magnetic power transmission of claim 6, wherein said first soft magnetic material element row is between said first magnetic pole row and said second magnetic pole row; and wherein said fifth movable member is configured to move relative to said first movable member and said second movable member along said predetermined direction.

8. The magnetic power transmission of claim 7, wherein said second soft magnetic material element row is between said third magnetic pole row and said fourth magnetic pole row; and wherein said sixth movable member is configured to move relative to said fifth movable member in an interlocked manner along said predetermined direction.

9. The magnetic power transmission system of claim 1, wherein said first movable member and said third movable member are configured integrally with each other as a seventh movable member; wherein said second movable member and said fourth movable member are configured integrally with each other as an eighth movable member; and wherein said fifth movable member and said sixth movable member are configured integrally with each other as a ninth movable member.

10. The magnetic power transmission system of claim 9, wherein each of said seventh eight, and ninth movable member comprise a slider relatively slidable with respect to said other sliders.

11. The magnetic power transmission system of claim 9, wherein each of said seventh eighth, and ninth movable member comprise a concentric rotor relatively rotatable with respect to said other rotors; and wherein of said plurality of first, second, third, and fourth magnetic poles and said plurality of first and second soft magnetic material elements being set to be equal in number to each other.

12. The magnetic power transmission system of claim 9, wherein one of said seventh, eighth, and ninth movable members is configured to be immovable.

13. The magnetic power transmission system of claim 9, further comprising a magnetic force-changing device for changing magnetic forces acting on said seventh, eighth, and ninth movable members.

14. A method of operating a magnetic power transmission system, comprising:
fixing a first movable member and a third movable member;
interlocking a second movable member to a fourth movable member; and
alternating continuously a generation of a plurality of first magnetic force lines with a generation of a plurality of second magnetic force lines for applying a driving force to said second movable member and said fourth movable member and for transmitting said driving force to a fifth movable member and a sixth movable member to operate said magnetic power transmission system,
wherein said fifth movable member is configured to move relative to said second movable member; and wherein said sixth movable member is configured to move relative to said fourth movable member.

15. The method of claim 14, wherein fixing said first movable member and said third movable member comprises said first movable member comprising a first magnetic pole row, wherein said first magnetic pole row comprises a plurality of first magnetic poles; and said third movable member comprising a third magnetic pole row, wherein said third magnetic pole row comprises a plurality of third magnetic poles.

16. The method of claim 14, wherein fixing said movable member and said third movable member comprises interlocking said first movable member to said third movable member.

17. The method of claim 15, wherein alternating continuously said generation of said plurality of first magnetic force lines with said generation of said plurality of second magnetic force lines further comprises said second movable member comprising a second magnetic pole row, wherein said second magnetic pole row comprises a plurality of second magnetic poles; and said fourth movable member comprising a fourth magnetic pole row, wherein said fourth magnetic pole row comprises a plurality of fourth magnetic poles.

18. The method of claim 17, wherein alternating continuously said generation of said plurality of first magnetic force lines with said generation of said plurality of second magnetic force lines further comprises generating each first magnetic force line between a first magnetic pole, a first soft magnetic material element, and a second magnetic pole; and generating each second magnetic force line between a third magnetic pole, a second soft magnetic material element, and a fourth magnetic pole.

19. The method of claim 18, wherein alternating continuously said generation of said plurality of first magnetic force lines with said generation of said plurality of second magnetic force lines further comprises, when each said first magnetic pole and each said second magnetic pole are in a first opposed position opposed to each other, each said third magnetic pole and each said fourth magnetic pole are in a second opposed position opposed to each other; when each said first magnetic pole and each said second magnetic pole in said first opposed position comprise polarities different from each other, each said third magnetic pole and each said fourth magnetic pole in said second opposed position comprise polarities identical to each other; and when each said first magnetic pole and each said second magnetic pole in said first opposed position comprise polarities identical to each other, each said third magnetic pole and each said fourth magnetic pole in said second opposed position comprise polarities different from each other.

20. The method of claim 18, wherein alternating continuously a generation of a plurality of first magnetic force lines with a generation of a plurality of second magnetic force lines further comprises when each said first magnetic pole and each said second magnetic pole are in said first opposed position, if each said first soft magnetic material element is between said first magnetic pole and said second magnetic pole, each said second soft magnetic material element is between two pairs of third magnetic poles and fourth magnetic poles adjacent to each other in said predetermined direction, and if each said second soft magnetic material element is between said third magnetic pole and said fourth magnetic pole, each said first soft magnetic material element is between two pairs of first magnetic poles and second magnetic poles which are adjacent to each other in said predetermined direction.

21. The method of claim 14, wherein said generation of said plurality of first magnetic force lines comprises moving a plurality of first soft magnetic material elements from between a plurality of first magnetic poles and a plurality of second magnetic poles so that a strong magnetic force acts on said plurality of first soft magnetic material elements for applying said driving force of said plurality of first magnetic force lines on said second movable member and for transmitting said driving force to said fifth movable member to move said fifth movable member in a predetermined direction.

22. The method of claim 21, wherein said generation of said plurality of second magnetic force lines comprises moving a plurality of fourth magnetic poles away from a plurality of opposed third magnetic poles, comprising polarities identical to said plurality of fourth magnetic poles, to a plurality of third magnetic poles, adjacent to said plurality of opposed third magnetic poles, comprising polarities different from said plurality of fourth magnetic poles so that a weak magnetic force acts on a plurality of second soft magnetic material elements for applying said driving force of said plurality of second magnetic force lines on said second movable member and for transmitting said driving force to said sixth movable member to move said sixth movable member in said predetermined direction.

23. The method of claim 22, wherein said generation of said plurality of first magnetic force lines further comprises moving each said first magnetic pole to a first opposed position opposed to each said second magnetic pole comprising a polarity identical to each said first magnetic pole, wherein each first soft magnetic material element is between two pairs of first magnetic poles and second magnetic poles adjacent to each other in said predetermined direction so that a weak magnetic force acts on each said first soft magnetic material element for applying said driving force of each said first magnetic force line on said second movable member and for transmitting said driving force to said fifth movable member to move said fifth movable member in said predetermined direction.

24. The method of claim 23, wherein said generation of said plurality of second magnetic force lines further comprises moving each said fourth magnetic pole closer to each said third magnetic pole comprising a polarity different from each said fourth magnetic pole so that a strong magnetic force acts on each said second soft magnetic material element for applying said driving force of each said second magnetic force line on said second movable member and for transmitting said driving force to said sixth movable member to move said sixth movable member in said predetermined direction.

25. The method of claim 14, wherein alternating continuously a generation of a plurality of first magnetic force lines with a generation of a plurality of second magnetic force lines further comprises accelerating and decelerating said driving force on said second movable member and said fourth movable member for transmitting said accelerated and decelerated driving force on said fifth movable member and said sixth movable member.

26. A magnetic power transmission system, comprising:
securing means for fixing a first movable member to a third movable member;
locking means for interlocking a second movable member to a fourth movable member, said fourth movable member configured to move in relation to said second movable member;
first generation means for generating a plurality of first magnetic force lines; and
second generation means for generating a plurality of second magnetic force lines,
wherein first generation means and second generation means are continuously alternately operated for applying a driving force to said second movable member and said fourth movable member and for transmitting said driving force to a fifth movable member and a sixth movable member to operate said magnetic power transmission system.
